(19) United States
(12) Patent Application Publication
(10) Pub. No.: US 2024/0127123 A1
(43) Pub. Date: Apr. 18, 2024

(54) FEDERATED LEARNING MODEL TRAINING METHOD AND APPARATUS, AND ELECTRONIC DEVICE

(71) Applicant: JINGDONG TECHNOLOGY HOLDING CO., LTD., Beijing (CN)

(72) Inventors: Peiqi WANG, Beijing (CN); Wenxi ZHANG, Beijing (CN); Songxiang GU, Beijing (CN); Liefeng BO, Beijing (CN); Mengzhe SUN, Beijing (CN)

(21) Appl. No.: 18/270,281

(22) PCT Filed: Dec. 31, 2021
(86) PCT No.: PCT/CN2021/143890

§ 371 Date: Jun. 29, 2023

(30) Foreign Application Priority Data
Dec. 31, 2020 (CN) 202011617342.X
Dec. 31, 2020 (CN) 202011621994.0

(51) Int. Cl. G06N 20/20

(52) U.S. Cl. CPC G06N 20/20

(57) ABSTRACT

In a method for training a federated learning model, a server obtains a target split mode corresponding to a training node in response to determining that the training node satisfies a preset splitting condition. The server notifies a client to perform, based on the target split mode, node splitting. The server performs a next round of training by taking a left subtree node generated by performing the node splitting as a new training node until an updated training node does not satisfy the preset splitting condition. The server performs a next round of training by taking another non-leaf node of the boosting tree as a new training node. The server stops training and generates a target federated learning model in response to determining that a node dataset of the plurality of boosting trees is empty.

### CROSS REFERENCE TO RELATED APPLICATIONS

This application is a national phase of International Application No. PCT/CN2021/143890, filed on Dec. 21, 2021, the content of which is hereby incorporated by reference in its entirety.

### TECHNICAL FIELD

The disclosure relates to a field of communication technologies, in particular to a method for training a federated learning model, an apparatus for training a federated learning model and an electronic device.

### BACKGROUND

Federated learning, an emerging fundamental Artificial Intelligence (AI) technology, is designed to perform efficient machine learning among multiple participants or computing nodes while ensuring information security, protecting terminal data and personal data privacy, and ensuring legal compliance in the exchange of big data. The machine learning algorithms that can be used for federated learning are not limited to neural networks but also include important algorithms such as random forests. The federated learning is expected to be the basis for the next generation of AI collaborative algorithms and collaborative networks.

### SUMMARY

Embodiments of a first aspect of the disclosure provides a method for training a federated learning model, performed by a server. The method includes obtaining a target split mode corresponding to a training node in response to determining that the training node satisfies a preset splitting condition, in which the training node is a node of one boosting tree among a plurality of boosting trees; notifying a client to perform, based on the target split mode, node splitting; performing a next round of training by taking a left subtree node generated by performing the node splitting as a new training node until an updated training node does not satisfy the preset splitting condition; performing a next round of training by taking another non-leaf node of the boosting tree as a new training node; and stopping training and generating a target federated learning model in response to determining that a node dataset of the plurality of boosting trees is empty.

Embodiments of a second aspect of the disclosure provides a method for training a federated learning model, performed by a client. The method includes: receiving a target split mode sent by a server in response to determining by the server that a training node satisfies a preset splitting condition, in which the training node is a node of one boosting tree among a plurality of boosting trees; and performing node splitting on the training node based on the target split mode.

Embodiments of a third aspect of the disclosure provides an electronic device. The electronic device includes: a memory, a processor and computer programs stored on the memory and runnable on the processor. When the computer programs are executed by the processor, the method for training a federated learning model of any one of the embodiments of the first aspect of the disclosure or any one of the embodiments of the second aspect of the disclosure is implemented.

### BRIEF DESCRIPTION OF THE DRAWINGS

FIG. 1 is a schematic diagram of a federated learning application scenario according to an embodiment of the disclosure.

FIG. 2 is a flowchart of a method for training a federated learning model according to an embodiment of the disclosure.

FIG. 3 is a flowchart of a method for training a federated learning model according to another embodiment of the disclosure.

FIG. 4 is a schematic diagram of data distribution according to an embodiment of the disclosure.

FIG. 5 is a schematic diagram illustrating node splitting according to an embodiment of the disclosure.

FIG. 6 is a schematic diagram of data distribution according to an embodiment of the disclosure.

FIG. 7 is a flowchart of a method for training a federated learning model according to another embodiment of the disclosure.

FIG. 8 is a flowchart of a method for training a federated learning model according to another embodiment of the disclosure.

FIG. 9 is a flowchart of a method for training a federated learning model according to another embodiment of the disclosure.

FIG. 10 is a flowchart of a method for training a federated learning model according to another embodiment of the disclosure.

FIG. 11 is a flowchart of a method for training a federated learning model according to another embodiment of the disclosure.

FIG. 12 is a flowchart of a method for training a federated learning model according to another embodiment of the disclosure.

FIG. 13 is a schematic diagram of bucket division in accordance with bucket mapping rules according to an embodiment of the disclosure.

FIG. 14 is a flowchart of a method for training a federated learning model according to another embodiment of the disclosure.

FIG. 15 is a flowchart of a method for training a federated learning model according to another embodiment of the disclosure.

FIG. 16 is a flowchart of a method for training a federated learning model according to another embodiment of the disclosure.

FIG. 17 is a flowchart of a method for training a federated learning model according to another embodiment of the disclosure.

FIG. 18 is a flowchart of a method for training a federated learning model according to another embodiment of the disclosure.

FIG. 19 is a flowchart of a method for training a federated learning model according to another embodiment of the disclosure.

FIG. 20 is a flowchart of a method for training a federated learning model according to another embodiment of the disclosure.

FIG. 21 is a flowchart of a method for training a federated learning model according to another embodiment of the disclosure.

FIG. 22 is a flowchart of a method for training a federated learning model according to another embodiment of the disclosure.

FIG. 23 is a flowchart of a method for training a federated learning model according to another embodiment of the disclosure.

FIG. 24 is a flowchart of a method for training a federated learning model according to another embodiment of the disclosure.

FIG. 25 is a flowchart of a method for training a federated learning model according to another embodiment of the disclosure.

FIG. 26 is a flowchart of a method for training a federated learning model according to another embodiment of the disclosure.

FIG. 27 is a flowchart of a method for training a federated learning model according to another embodiment of the disclosure.

FIG. 28 is a flowchart of a method for training a federated learning model according to another embodiment of the disclosure.

FIG. 29 is a flowchart of a method for training a federated learning model according to another embodiment of the disclosure.

FIG. 30 is a flowchart of a method for training a federated learning model according to another embodiment of the disclosure.

FIG. 31 is a flowchart of a method for training a federated learning model according to another embodiment of the disclosure.

FIG. 32 is a flowchart of a method for training a federated learning model according to another embodiment of the disclosure.

FIG. 33 is a schematic diagram of an apparatus for training a federated learning model according to an embodiment of the disclosure.

FIG. 34 is a schematic diagram of an apparatus for training a federated learning model according to another embodiment of the disclosure.

FIG. 35 is a schematic diagram of an apparatus for training a federated learning model according to another embodiment of the disclosure.

FIG. 36 is a schematic diagram of an apparatus for training a federated learning model according to another embodiment of the disclosure.

FIG. 37 is a schematic diagram of an apparatus for training a federated learning model according to another embodiment of the disclosure.

FIG. 38 is a schematic diagram of an apparatus for training a federated learning model according to another embodiment of the disclosure.

FIG. 39 is a schematic diagram of an apparatus for training a federated learning model according to another embodiment of the disclosure.

FIG. 40 is a schematic diagram of an apparatus for training a federated learning model according to another embodiment of the disclosure.

FIG. 41 is a schematic diagram of an apparatus for training a federated learning model according to another embodiment of the disclosure.

FIG. 42 is a schematic diagram of an apparatus for training a federated learning model according to another embodiment of the disclosure.

FIG. 43 is a schematic diagram of an apparatus for training a federated learning model according to another embodiment of the disclosure.

FIG. 44 is a schematic diagram of an apparatus for training a federated learning model according to another embodiment of the disclosure.

FIG. 45 is a schematic diagram of an apparatus for training a federated learning model according to another embodiment of the disclosure.

FIG. 46 is a schematic diagram of an apparatus for training a federated learning model according to another embodiment of the disclosure.

FIG. 47 is a schematic diagram of an apparatus for training a federated learning model according to another embodiment of the disclosure.

FIG. 48 is a schematic diagram of an electronic device according to an embodiment of the disclosure.

### DETAILED DESCRIPTION

To well understand the foregoing technical solutions, embodiments of the disclosure will be described in detail below with reference to the accompanying drawings. Although the embodiments of the disclosure are shown in the accompanying drawings, it is understandable that the disclosure can be implemented in various manners and should not be limited by the embodiments set forth herein. Instead, these embodiments are described to provide a more thorough understanding of the disclosure and a complete scope of this disclosure to those skilled in the art.

It is understandable that the term “and/or” describing the associated relation of the associated objects involved in the embodiments of the disclosure indicates three relations. For example, A and/or B may indicates three relations, i.e., only A, both A and B, and only B, in which A and B may be singular or plural. The character “I” generally indicates that the associated objects before and after is an “or” relation.

Firstly, some of the vocabularies involved in the embodiments of the disclosure are introduced.

Homogeneous data: data records owned by different data providers have the same feature attributes.

Heterogeneous data: data records owned by different data providers have different feature attributes, except for the data instance identity document (ID).

XGBoost: XGB for short, a scalable boosting tree-machine learning system.

Before introducing the technical solution of the disclosure, the problems existing in the existing technology and the technical conception process of the disclosure are firstly introduced in combination with a specific application scenario of this disclosure.

In practice, it is difficult to guarantee that data from multiple parties cooperating in the federated learning are either all heterogeneous or all homogeneous. As a result, in performing a federated learning training with the boosting tree, some homogeneous data or heterogeneous data will be discarded, and horizontal federated learning or vertical federated learning is performed. However, the performance of a model obtained after the federated learning training is poor since a large amount of data is discarded. Moreover, even if the horizontal federated learning or vertical federated learning is performed, it needs to guarantee that labels of the data exist in one party, not randomly in multiple parties, which is almost impossible in reality, and thus the existing technology also limits the practical application of federated learning.

In view of the above problems, the inventors found that a federated learning design of mixing the horizontal federated learning and the vertical federated learning can solve the problem that the federated learning needs to care about the data distribution mode, the problem that all data cannot be fully utilized for learning, and the problem that the performance of the trained model is poor due to insufficient utilization of all data.

Through the federated learning design, this solution tends to adopt the vertical federated learning mode (i.e., vertical boosting tree) when there is more heterogeneous data than homogeneous data, so that the trained model can have lossless characteristics, and the homogeneous data can also be used. In addition, this solution tends to use the horizontal federated learning mode (i.e., horizontal boosting tree) when there is more homogeneous data than heterogeneous data, and the heterogeneous data is also used for model training, so that the trained model has a vertical lossless ability, which improves the performance of the model.

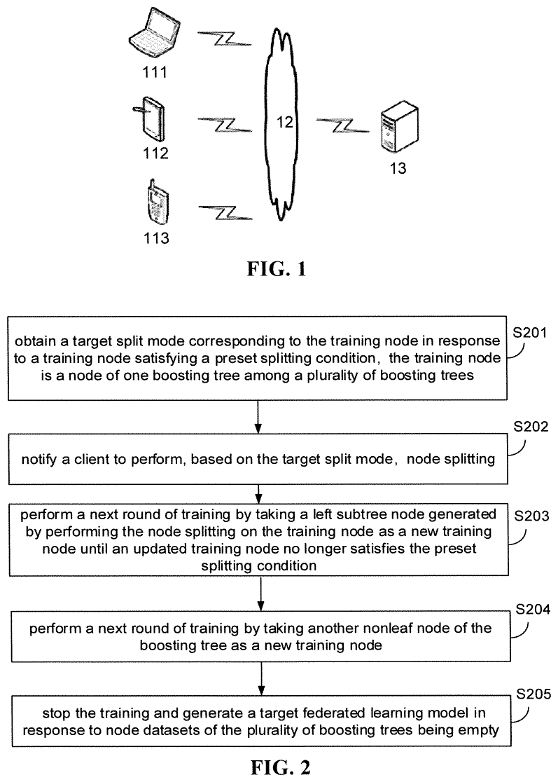

FIG. 1 is a schematic diagram of an application scenario of a method for training a federated learning model according to an embodiment of the disclosure. As illustrated in FIG. 1, the application scenario may include at least one client (FIG. 1 illustrates three clients, namely client 111, client 112, and client 113), a network 12, and a server 13. Each client may communicate with the server 13 via the network 12.

It is understandable that FIG. 1 is only a schematic diagram of an application scenario according to the embodiment of the disclosure. The embodiment of the disclosure does not limit the devices included in FIG. 1 or the location relation among the devices in FIG. 1. For example, the application scenario illustrated as FIG. 1 may also include a data storage device, which may be an external memory relative to the server 13 or an internal memory integrated in the server 13.

The disclosure provides a method for training a federated learning model, an apparatus for training a federated learning model, and a storage medium, to improve the performance of the trained model by mixing the horizontal federated learning and the vertical federated learning. In the following context, the technical solutions of the disclosure will be described in detail by specific embodiments. It is understandable that these specific embodiments below can be combined with each other, and the same or similar concepts or processes may not be repeated in some embodiments.

The method for training a federated learning model, the apparatus for training a federated learning model, and the electronic device according to embodiments of the disclosure are described below with reference to the accompanying drawings.

FIG. 2 is a flowchart of a method for training a federated learning model according to an embodiment of the disclosure.

As illustrated in FIG. 2, the method for training a federated learning model according to embodiments of the disclosure is explained and described by taking a server as the executing subject. The method includes the following.

At block S201, a target split mode corresponding to a training node is obtained, in response to the training node satisfying a preset splitting condition, in which the training node is a node of one boosting tree among a plurality of boosting trees.

In embodiments of the disclosure, if the training node satisfies the preset splitting condition, it means that the current training node needs to be split. Therefore the target split mode corresponding to the training node can be obtained.

The preset splitting condition can be set according to the actual situation. For example, the preset splitting condition can be that a level of the current training node does not reach a required maximum tree depth or a loss function does not satisfy constraint conditions.

The target split mode includes a horizontal split mode and a vertical split mode.

The boosting tree refers to a boosting method that adopts an additive model and a forward distribution algorithm and uses a decision tree as the basis function.

At block S202, a client is notified to perform, based on the target split mode, node splitting.

In embodiments of the disclosure, after obtaining the target split mode corresponding to the training node, the server can send the obtained target split mode to one or more clients to notify the one or more clients to perform, based on the target split mode, the node splitting. Correspondingly, each client can receive the target split mode from the server and perform the node splitting on the training node based on the target split mode.

At block S203, a next round of training is performed by taking a left subtree node generated by splitting the training node as a new training node until an updated training node does not satisfy the preset splitting condition.

In embodiments of the disclosure, the server can update the training node to the left subtree node generated by splitting the training node to perform the next round of training, and determine whether the level of the updated training node satisfies the preset splitting condition. When the server determines that the updated training node needs to be split, i.e., the preset splitting condition is satisfied, the target split mode corresponding to the updated training node is obtained, and the each client is notified to continue to perform the node splitting based on the newly obtained target split mode until the updated training node no longer satisfies the preset splitting condition. The preset splitting condition can include a threshold for the tree depth, a threshold for the number of samples after splitting the training node, or a threshold for an error of the federated learning model.

At block S204, a next round of training is performed by taking another non-leaf node of the boosting tree as a new training node.

In embodiments of the disclosure, the server can backtrack to another non-leaf node of the current boosting tree and use the non-leaf node as the current training node to perform the next round of training.

At block S205, the training is stopped and a target federated learning model is generated in response to a node dataset of the plurality of boosting trees being empty.

In embodiments of the disclosure, if the node dataset of the plurality of boosting trees is empty, the training can be stopped and the target federated learning model can be generated. Further, the generated target federated learning model can be verified until a preset number of training times is reached, and then information is deleted and the model is left.

Therefore, with the method for training a federated learning model according to the disclosure, the server has a propensity of automatically selecting a matched learning mode by mixing the horizontal split mode and the vertical split mode, without considering the data distribution mode, which solves the problems that the training process of the existing federated learning models cannot fully utilize all the data for learning and has poor training results due to insufficient data utilization, reduces the loss of the federated learning model and improves the performance of the federated learning model.

It is understandable that in this disclosure, in obtaining the target split mode corresponding to the training node, respective split values can be obtained by performing federated learning operations in collaboration with each client, and the target split mode corresponding to the training node can be determined based on the split values.

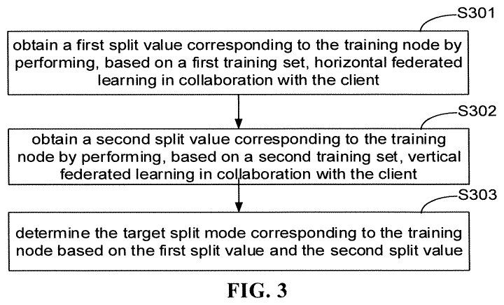

As a possible implementation mode, as illustrated in FIG. 3, based on the above, the process of obtaining the target split mode corresponding to the training node at the above block includes the following.

At block S301, a first split value corresponding to the training node is obtained by performing, based on a first training set, horizontal federated learning in collaboration with one or more clients.

It is understandable that when the training node needs to be split, it needs to determine a split mode, i.e., either a horizontal split mode or a vertical split mode. Most of the nodes are subjected to two candidate splitting operations, one is the horizontal splitting and the other one is the vertical splitting, and a split mode with a higher splitting gain is selected from these two candidate split modes as the final split mode.

In the pre-determination, nodes that satisfy certain conditions can only be subjected to either the vertical splitting or the horizontal splitting and the splitting result is directly used as the final split result, which is described as follows.
(1) The deeper the tree is, the smaller the total number of samples to be split at a node is. If a ratio of the number of common samples to the number of samples at the node is less than a preset value, e.g., 10%, it means that there are very few common samples. The data distribution mode of the node can be considered as a horizontal distribution mode, and only the horizontal splitting is performed.
(2) If the ratio of the number of common samples to the number of samples at the node exceeds a preset value, e.g., 98%, only the vertical splitting is performed.

It is understandable that the two aforementioned pre-determination conditions are set for saving training time, and the two preset values can be set in the training parameters.

Data involved in the two splitting modes, i.e., the horizontal split mode and the vertical split mode, will be explained below.

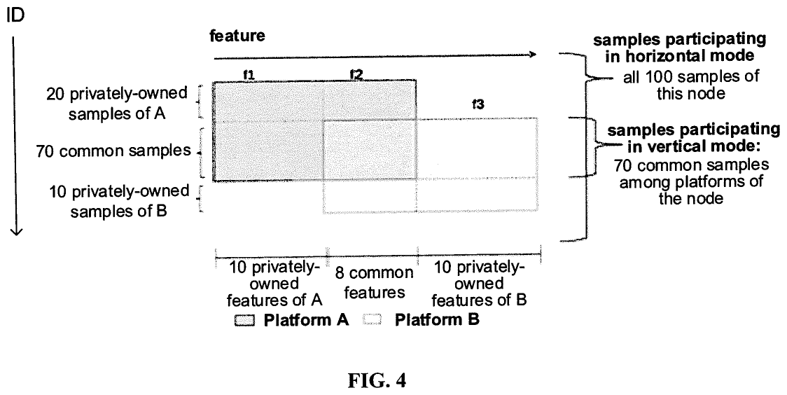

For example, as illustrated in FIG. 4, a total of 10,000 samples can be used for training, and there are 100 samples at a certain node after splitting the 10,000 samples. The data distribution is as follows: 70 of the 100 samples are commonly-owned by both platforms, called common samples. Platform A has 90 samples (including 20 privately-owned samples and 70 common samples), and platform B has 80 samples (including 10 privately-owned samples and 70 common samples). The samples from the Platform A totally have 18 features (including 10 privately-owned features and 8 commonly-owned features), and the samples from the platform B totally have 18 features (including 10 privately-owned features and 8 commonly-owned features).

For the horizontal splitting (also called horizontal split mode), all samples of a node are involved in the splitting, and multiple candidate features and feature thresholds are selected by the server.

For a common feature f and its values v, the platform A splits its 90 native samples to the left subtree and the right subtree respectively, and the platform B splits its 80 native samples to the left subtree and the right subtree respective. The server is notified of this sample splitting way and calculates a splitting gain for this sample splitting way of splitting 100 samples to the left subtree and the right subtree, as the gain of this feature f.

For a privately-owned feature f of the platform A and its values v, the platform A splits its native 90 samples to the left subtree and the right subtree respectively, and the platform B splits its native 70 common samples to the left subtree and the right subtree respectively and assigns all 10 samples that do not have the feature f to either the left subtree or the right subtree. The server is notified of these two sample splitting ways. The server calculates respective splitting gains for these two sample splitting ways of splitting 100 samples, and a larger splitting gain is determined as the gain of this feature f.

For a privately-owned feature f of the platform B and its values v, the process is similar to the above case.

The server determines a largest gain among all features and represents it by gainl.

For the vertical splitting, only the 70 common samples of this node are involved in the splitting. Similar to the existing vertical federated learning, a calculated maximum splitting gain among all features of the 70 samples is represented by gain2.

A split mode corresponding to a larger one between the maximum horizontal splitting gain, i.e., gain1, and the maximum vertical splitting gain, i.e., gain2, is determined to perform the splitting on the node and the method proceeds to a next node.

It is understandable that regardless of whether the horizontal split mode or the vertical split mode is adopted, the set of samples of the node is split according to one of the following rules: the maximum gain is obtained from a native feature f1 of the platform A; the maximum gain is obtained from a common feature f2; and the maximum gain is obtained from a native feature f3 of the platform B.

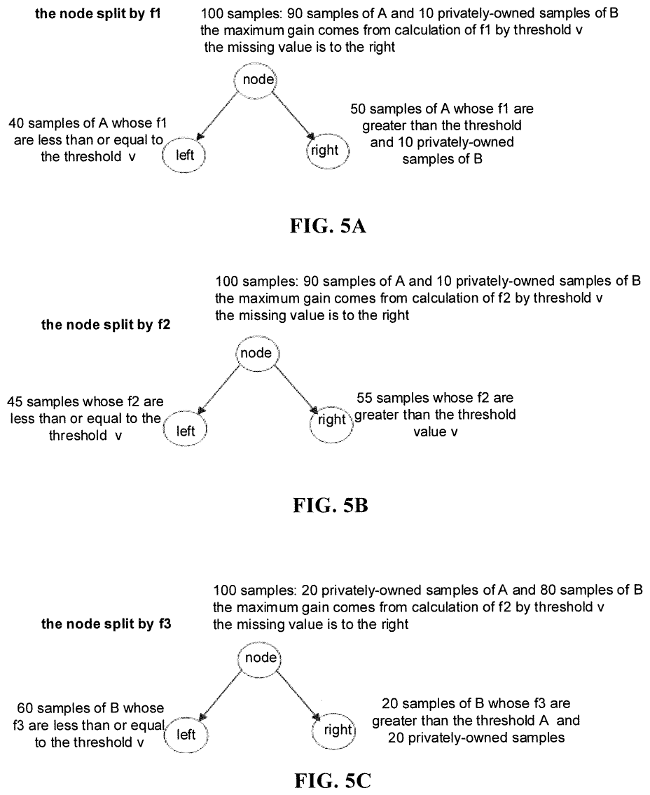

For example, as illustrated in FIG. 5A, if the node is split according to f1, among the 90 native samples of the platform A, samples whose values for the feature f1 are less than or equal to a threshold are assigned to the left subtree space and samples whose values for the feature f1 are greater than the threshold are assigned to the right subtree space. For 10 samples of the platform B that does not have a value for the feature f1, if the splitting mode corresponding to the maximum gain sets that missing values belong to the right subtree, then the 10 samples are assigned to the right subtree space, and if the splitting mode sets that missing values belong to the left subtree, then the 10 samples are assigned to the left subtree space.

As illustrated in FIG. 5B, if the node is split according to f1, all samples have respective values for the feature f2. Samples whose values for the feature f1 are less than or equal to a threshold are assigned to the left subtree space and samples whose values for the feature f1 are greater than the threshold are assigned to the right subtree space.

As shown in FIG. 5C, if the node is split according to f3, the process is similar to the case of splitting the node according to f1, which is not repeated here.

In embodiments of the disclosure, each client may perform the horizontal federated learning based on the first training set to obtain the first split value corresponding to the training node and send the first split value to the server. Correspondingly, the server may receive the first split value corresponding to the training node to obtain the first split value corresponding to the training node.

At block S302, a second split value corresponding to the training node is obtained by performing, based on a second training set, vertical federated learning in collaboration with the one or more clients.

In embodiments of the disclosure, each client may perform the vertical federated learning based on the second training set, to obtain the second split value corresponding to the training node and send the second split value to the server. Correspondingly, the server may receive the second split values corresponding to the training node, to obtain the second split value corresponding to the training node.

At block S303, the target split mode corresponding to the training node is determined based on the first split value and the second split value.

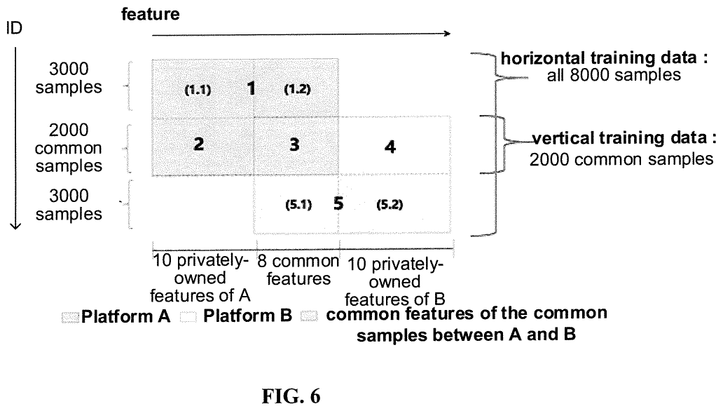

It is understandable that the traditional federated learning mainly includes the horizontal federated learning and the vertical federated learning. The horizontal federated learning uses data having the identical features among multiple platforms, i.e., horizontal data, such as the data (1.2)+(3)+(5.1) in FIG. 6. The vertical federated learning uses data having identical sample identity documents (IDs) among multiple platform, i.e., vertical data, such as data (2)+(3)+(4) in FIG. 6. As discussed above, in the related art, the modeling is only performed on either the horizontal data or the vertical data. In other words, only some data in FIG. 6 can be used.

In embodiments of the disclosure, the first training set, i.e., the data involved in the horizontal federated learning, refers to all data samples from multiple clients, such as data (1)+(2)+(3)+(4)+(5) in FIG. 6. The second training set, i.e., the data involved in the vertical federated learning, refers to data samples that are commonly owned by multiple clients, such as (2)+(3)+(4) in FIG. 6, and all features of these data samples are involved in the training. Therefore, the method for training a federated learning model according to embodiments of the disclosure can be performed on horizontal-vertical cross data. In other words, all data in FIG. 6 is used.

In embodiments of the disclosure, the one or more clients collaborates to perform the horizontal federated learning and the vertical federated learning based on the first training set and the second training set respectively, to obtain the first split value and the second split value corresponding to the training node.

It is understandable that in the disclosure, for determining the target split mode corresponding to the training node based on the first split value and the second split value, the first split value is compared with the second split value to determine a target split value, and the target split mode can be determined based on the target split value.

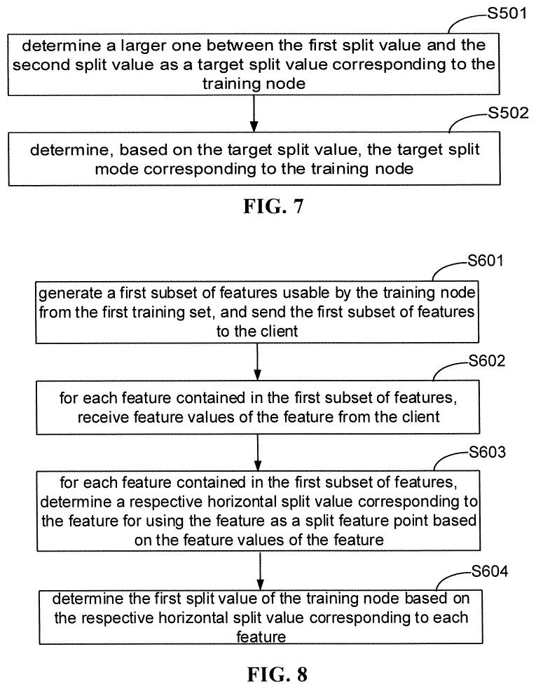

As a possible implementation, as illustrated in FIG. 7, based on the above, the process of determining the target split mode corresponding to the training node based on the first split value and the second split value in the above block S303 includes the following.

At block S501, a larger one between the first split value and the second split value is determined as a target split value corresponding to the training node.

In embodiments of the disclosure, after the server obtains the first split value and the second split value of the training node, the server compares the first split value and the second split value, and takes the larger one as the target split value corresponding to the training node.

For instance, if the first split value is Gain1, the second split value is Gain2, and Gain1>Gain2, then the Gain1 is used as the target split value corresponding to the training node.

At block S502, a split mode corresponding to the training node is determined based on the target split value.

In embodiments of the disclosure, after taking the larger one between the first split value and the second split value as the target split value corresponding to the training node, the server can determine the split mode of the training node based on the target split value.

Therefore, with the method for training a federated learning model according to the disclosure, the one or more clients collaborates to perform the horizontal federated learning and the vertical federated learning to obtain the first split value and the second split value respectively, and the larger one between the first split value and the second split value is determined as the target split value corresponding to the training node. The split mode corresponding to the training node is determined according to the target split value, so that the propensity of automatically selecting a matched learning mode according to the target split value can be realized, without caring about the data distribution mode.

It is understandable that in the disclosure, in obtaining the first split value corresponding to the training node by performing, based on the first training set, the horizontal federated learning in collaboration with each client, respective horizontal split values corresponding to features can be obtained, and the first split value of the training node can be determined based on the respective horizontal split values.

As a possible implementation, as illustrated in FIG. 8, on the basis of the above, the process of obtaining the first split value corresponding to the training node by performing, based on the first training set, the horizontal federated learning in collaboration with each client in the above block S301 includes the following.

At block S601, a first subset of features usable by the training node is generated from the first training set and sent to each client.

In some examples, the server may randomly generate, from the first training set, the first subset of features usable by the current training node. For example, the server can randomly select a half of features of the first training set to form a new feature sets as the first subset of features, and send the first subset of features to each client. Correspondingly, each client can receive the first subset of features. Each client obtains, for each feature included in the first subset, feature values of the feature through traversal, and sends features value of the feature based on the native data, i.e., feature values of natively-stored features, to the server.

At block S602, for each feature included in the first subset of features, a respective feature value of the feature is received from each client.

In embodiments of the disclosure, for each feature included in the first subset, each client can send its feature value of the feature to the server. Correspondingly, for each the feature included in the first subset of features, the server can receive the feature values of the feature sent by the clients.

At block S603, for each feature included in the first subset of features, a respective horizontal split value corresponding to the feature is determined for using the feature as a split feature point based on the feature values of the feature.

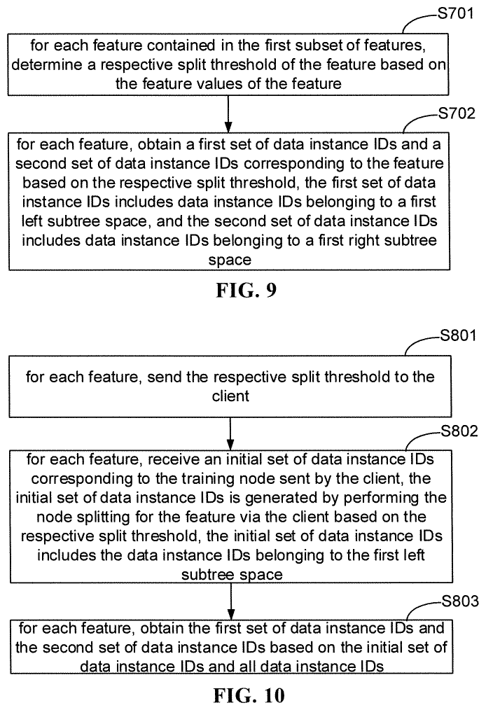

As a possible implementation, as illustrated in FIG. 9, based on the above, the process of determining, for each feature included in the first subset of features, the respective horizontal split value corresponding to the feature for using the feature as the split feature point based on the feature values of the feature in the above block S603 includes the following.

At block S701, for each feature included in the first subset of features, a respective split threshold is determined for the feature based on the feature values of the feature.

In embodiments of the disclosure, after the server receives the feature values of each feature included in the first subset sent by each client, a list of feature values can be generated based on the feature values. Further, for a feature included in the first subset of features, one feature value may be randomly selected from the list of feature values as a global optimal split threshold of the feature.

At block S702, for each feature, a first set of data instance IDs and a second set of data instance IDs corresponding to the feature are obtained based on the respective split threshold, in which the first set of data instance IDs includes data instance IDs belonging to a first left subtree space, and the second set of data instance IDs includes data instance IDs belonging to a first right subtree space.

As a possible implementation, as illustrated in FIG. 10, based on the above, the process of obtaining, for each feature, the first set of data instance IDs and the second set of data instance IDs corresponding to the feature based on the respective split threshold in the above block S702 includes the following.

At block S801, the respective split threshold is sent to each client.

In embodiments of the disclosure, after determining the respective split threshold of each feature, the respective split threshold can be broadcasted to the clients. Correspondingly, for each feature, each client can receive the respective split threshold, obtain an initial set of data instance IDs corresponding to the training node based on the respective split threshold of the feature, and send the initial set of data instance IDs to the server.

At block S802, an initial set of data instance IDs corresponding to the training node is received from each client, in which the initial set of data instance IDs is generated by performing, for the feature via the client based on the split threshold, the node splitting, and the initial set of data instance IDs includes the data instance IDs belonging to the first left subtree space.

In embodiments of the disclosure, the server can receive the IL sent by each client. The IL is the initial set of data instance IDs including the data instance IDs belonging to the first left subtree space.

At block S803, the first set of data instance IDs and the second set of data instance IDs are obtained based on the initial set of data instance IDs and all data instance IDs.

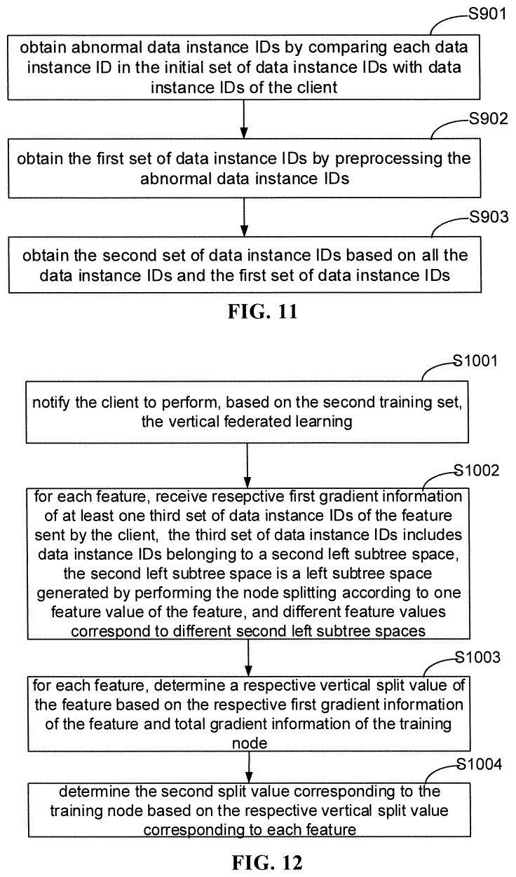

As a possible implementation, as illustrated in FIG. 11, based on the above, the process of obtaining the first set of data instance IDs and the second set of data instance IDs based on the initial set of data instance IDs in the above block S803 includes the following.

At block S901, for each client, abnormal data instance IDs are obtained by comparing each data instance ID included in the initial set of data instance IDs with data instance IDs of the client.

The abnormal data instance IDs mean redundant data instance IDs or contradictory data instance IDs.

At block S902, the first set of data instance IDs is obtained by preprocessing the abnormal data instance IDs.

In embodiments of the disclosure, after receiving the ILs, the server can filter out the data instance IDs that are repeated among the ILs and process the data instance IDs that are contradictory among the ILs, to determine the final IL.

For instance, an instance ID of a client will be added to the IL, but an instance ID of another client does not added to the IL; at this time, it is considered that this instance ID of another client should be included in the IL.

At block S903, the second set of data instance IDs is obtained based on all data instance IDs and the first set of data instance IDs.

In embodiments of the disclosure, after obtaining the first set of data instance IDs, the first set of data instance IDs (i.e., the final IL) can be removed from all data instance IDs to obtain the second set of data instance IDs (i.e., the IR).

It is understandable that in the disclosure, for obtaining the second split value corresponding to the training node by performing, based on the second training set, the vertical federated learning in collaboration with the one or more clients based on the second training set, the second split value of the training node can be determined based on a respective vertical split value corresponding to each feature.

As a possible implementation, as illustrated in FIG. 12, based on the above, the process of obtaining the target split mode corresponding to the training node includes the following.

At block S1001, each client is notified to perform the vertical federated learning based on the second training set.

In embodiments of the disclosure, after the server inform each client to perform, based on the second training set, the vertical federated learning the server can send a gradient information request to each client to obtain Gkv and Hkv information. Correspondingly, each client can obtain data that has not been processed yet at the current node based on data of common IDs to randomly form a feature set, and perform bucket mapping on each sample based on each feature k included in the feature set and a respective value v of each sample for the corresponding feature k, to calculate the Gkv and Hkv of the left subtree space as the first gradient information. The homomorphic encryption processing is performed on the first gradient information and the processed first gradient information is sent to the server. The Gkv and Hkv are represented by:

Gₖᵥ=Σi∈{i|s_{k,v}≥x_{i,k}>s_{k,v-1}} [symbol] gᵢ [symbol] ;

Hₖᵥ=Σi∈{i|s_{k,v}≥x_{i,k}>s_{k,v-1}};

where x_{i,k} represents a value of an data instance xᵢ for the feature k.

For instance, values from 1 to 100 for the age is mapped to three buckets: a bucket of values less than 20 for the age, a bucket of values from 20 to 50 for the age, and a bucket of values greater than 50 for the age. Samples in a bucket are either all assigned to the left or all to the right. Theoretically, the G value and H value sent to the server are cumulative sums respectively. For example, in the above instance, three G values (respectively corresponding to the G values of the left subtrees) should be sent: a G value equaling to a sum of Gs for ages from 1 to 20, a G value equaling to a sum of Gs for ages from 1 to 50, and a G value equaling to a sum of Gs for ages from 1 to 100. Since the ciphertext operation of homomorphic encryption is slow and the traffic volume will increase due to the long ciphertext, in practice, the client sends following three G values of the buckets: a G value equaling to a sum of Gs for ages from 1 to 20, a G value equaling to a sum of Gs for ages from 20 to 50, and a G value equaling to a sum of Gs for ages greater than 50. After a platform having a label receives these 3 G values of the buckets, the platform first decrypts them into plaintext and then calculates the G value corresponding to the sum of Gs for ages from 1 to 20, the G value corresponding to the sum of Gs for ages from 1 to 50, and the G value corresponding to the sum of Gs for ages from 1 to 100. The two equations mentioned above represent this process, indicating the calculation of the sum of a respective g value of each bucket. In these equations, s_{k,v} represents a maximum value (e.g., age is 50) taken by the current bucket and s_{k,v-1} is a maximum feature value (e.g., age is 20) taken by a previous bucket such that x of ages from 20 to 50 can be obtained. By means of feature bucketing, the amount of computation can be reduced.

At block S1002, for each feature, respective first gradient information of at least one third set of data instance IDs of the feature sent by each client is received. The third set of data instance IDs includes data instance IDs belonging to a second left subtree space, the second left subtree space is a left subtree space generated by preforming, based on a feature value of the feature, the node splitting, and different feature values correspond to different second left subtree spaces.

In embodiments of the disclosure, for each feature, each client can obtain all feature values of the feature, perform feature bucketing based on the feature values, and obtain respective first gradient information of at least one third set of data instance IDs corresponding to buckets for the feature. Correspondingly, the server can receive the respective first gradient information of at least one third set of data instance IDs for each feature from each client.

At block S1003, for each feature, the respective vertical split value of the feature is determined based on the respective first gradient information of the feature and total gradient information of the training node.

At block S1004, the second split value corresponding to the training node is determined based on the respective vertical split value corresponding to each feature.

The gradient information is explained below according to the following example.

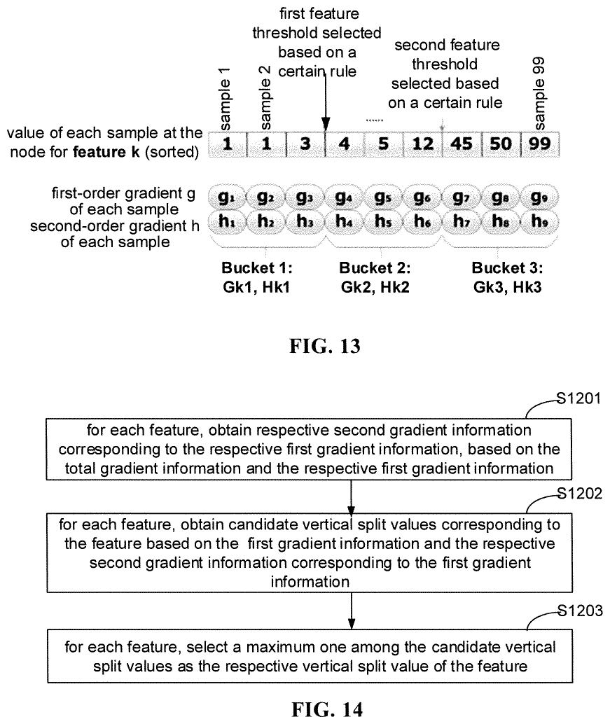

For instance, as illustrated in FIG. 13, for a feature k of client A, all samples at the current node are sorted in an ascending order of the feature values of the feature k. These sorted samples can be divided and mapped to multiple data buckets (corresponding to multiple feature value thresholds in an ascending order) according to a bucket mapping rule. Further, a G value equaling to a sum of the first-order gradients g and a H value equaling to a sum of the second-order gradients h of the samples contained in the v^{th} bucket are calculated, i.e., Gkv and Hkv corresponding to the v^{th} feature value threshold v.

The Gkv represents a sum of the first-order gradients g of all samples in the v^{th} bucket after dividing samples of the node that are sorted based on the value of the feature k into multiple data buckets.

The Hkv represents a sum of the second-order gradients h of these samples.

It is understandable that there are many bucket mapping rules, and the specific bucket mapping rule used in the disclosure is not limited as long as ensuring that samples having the same feature value, such as two samples having the same value, i.e., 1, in FIG. 11, are in the same data bucket.

For example, samples (e.g., n samples) having the same value for a feature can be mapped to a bucket. If a feature have m feature values, there are m buckets and corresponding feature value thresholds are these m feature values.

For example, the number of buckets can be limited, for example, there are m buckets at most. In this case, if the number of values for this feature k is less than m, the samples can be divided according to the previous mode. If the number of values for this feature k is greater than m, the samples can be divided into m buckets according to the approximate equal division method.

It is understandable that for determining the respective vertical split value of each feature, a maximum value among candidate vertical split values can be selected as the vertical split value of the feature.

As a possible implementation, as illustrated in FIG. 14, based on the above, the process of, for each feature, determining the respective vertical split value of the feature based on the respective first gradient information of the feature and the total gradient information of the training node in the above block S1003 includes the following.

At block S1201, for each feature, respective second gradient information corresponding to the respective first gradient information is obtained based on total gradient information and the respective first gradient information.

At block S1202, candidate vertical split values corresponding to the feature are obtained based on the respective first gradient information and the respective second gradient information corresponding to the respective first gradient information.

At block S1203, a maximum value among the candidate vertical split values is determined as the vertical split value of the feature.

The first gradient information includes a sum of first-order gradients of the feature corresponding to data instances belonging to the second left subtree space and a sum of second-order gradients of the feature corresponding to the data instances belonging to the second left subtree space. The second gradient information includes a sum of first-order gradients of the feature corresponding to data instances belonging to second right subtree space and a sum of second-order gradients of the feature corresponding to the data instances belonging to the second right subtree space.

As a possible implementation, in embodiments of the disclosure, the server requests the Gkv and Hkv information from each client. Correspondingly, each client can obtain data that has not been processed yet at the current node based on the data of the common IDs to randomly form a feature set, perform bucket mapping on each sample based on each feature k in the feature set and each feature value v of the corresponding feature, calculate the Gkv and Hkv of the left subtree space, perform the homomorphic encryption on the Gkv and Hkv and send the processed Gkv and Hkv to the server. In addition, each client can calculate some intermediate results of the loss function based on the common data IDs and the native data, such as the first-order derivative gᵢ and the second-order derivative hᵢ of the loss function, and send them to the server.

The server can decrypt the processed Gkv and Hkv sent by each client, and calculate a GL value equaling to the sum of all gᵢ in the left subtree space of the current node, a GR value equaling to the sum of all gᵢ in the right subtree space of the current node, a HL equaling to the sum of all hᵢ in the left subtree space of the current node, and a HR value equaling to the sum of all hᵢ in the right subtree space of the current node based on the data corresponding to the common IDs of the current node and all the gᵢ and hᵢ obtained.

Taking the XGB as an example, the objective function is represented by a following equation:

$${L}^{( t )} = {\sum }_{i = 1}^{𝔫} [ {g}_{i} {f}_{t} ( {x}_{i} ) + \frac{1}{2} {h}_{i} {f}_{t}^{2} ( {x}_{i} ) ] + Ω ( {f}_{t} ) .$$

The XGB proposes to approximately represent the above equation using a second-order Taylor expansion. The second-order Taylor expansion is given by:

$${L}^{( t )} ≃ {\sum }_{i = 1}^{𝔫} [ l ( {y}_{i} , {\hat{y}}_{i}^{( t - 1 )} ) + {g}_{i} {f}_{t} ( {x}_{i} ) + \frac{1}{2} {h}_{i} {f}_{t}^{2} ( {x}_{i} ) ] + Ω ( {f}_{t} ) + constant ,$$

and gᵢ and hᵢ are calculated according to the following equations respectively:

gᵢ=∂_{ŷ}_{^{(t−1)}}l(yᵢ,ŷ^{(t-1)}), hᵢ=∂_{ŷ}_{ᵢ}_{^{(t−1)}}²l(yᵢ, ŷ^{(t-1)}).

In the above Taylor expansion, gᵢ is the first-order derivative and hᵢ is the second-order derivative, and the GL value and the HL value can be calculated according to the following equations respectively:

GL=Σⱼ₌₁ⁿ(gⱼ),

HL=Σⱼ₌₁ⁿ(hⱼ),

where n represents the number of instances in the left subtree space. In other words, there are a total of n instances in the left subtree space.

The server can calculate a respective optimal splitting point for each feature based on the aforementioned results, and determine a global optimal splitting point “(k, v, Gain)” based on information of these optimal splitting points. If several clients have the same feature, the server will randomly take one received Gkv as the Gkv of the current feature, and similarly, the server will randomly take one received Hkv as the Hkv of the current feature.

The server can ask for IL information from each client based on “(k, v, Gain)”. Correspondingly, each client receives the splitting point information “(k, v, Gain)”, finds the splitting point threshold represented by “value”, and records the information “(k, value)” of the splitting point. The native dataset is split according to the splitting point, to obtain the IL, and each client sends “(record, IL, value)” to the server, in which “record” represents the index of the recorded information in the client.

The server receives the information “(record, IL, value)” sent by each client, splits all the instances having the common IDs in the node space, and associates the current node with each client through “(client id, record)”. The information “(client id, record_id, IL, feature_name, feature_value)” is recorded as the vertical split information, i.e., the vertical split value of a feature.

It is understandable that the node splitting selects the feature and value corresponding to the optimal splitting point, such that the samples of the current node are split, based on the values of the samples for the feature, to a left subtree node and a right subtree node.

At block S604, the first split value of the training node is determined based on the respective horizontal split value corresponding to each feature.

It is understandable that in embodiments of the disclosure, optionally, the horizontal splitting can be performed firstly and then the vertical splitting is performed; alternatively, the vertical splitting can be performed and then the horizontal splitting is performed.

Since the horizontal splitting mode uses all the data while the vertical splitting mode uses only some data having the same ID, it can be seen that for the horizontal splitting mode, more data is utilized and there is a higher probability of obtaining better results, and for the vertical splitting mode, there is less data interaction between the client and the server and the data interaction speed is faster. Therefore, in order to obtain training interim results of a deeper level as much as possible when training is interrupted, the horizontal splitting can be performed before the vertical splitting.

It is understandable that, in embodiments of the disclosure, if the training node satisfies the preset splitting condition, it means that the current training node needs to be split, in which case, the target splitting mode corresponding to the training node can be obtained. If the training node does not satisfy the preset splitting condition, it means that the training node does not need to be split, in which case, the training node can be determined as a leaf node and the weight value of the leaf node can be sent to each client.

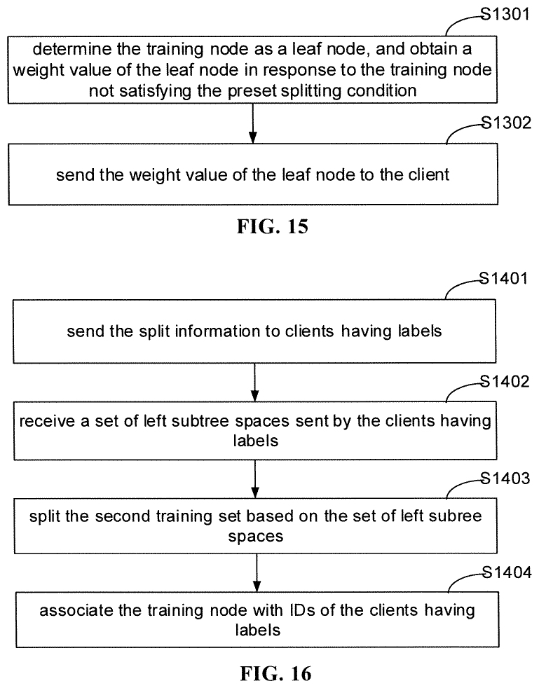

As a possible implementation, as illustrated in FIG. 15, on the basis of the above, the method includes the following.

At block S1301, the training node is determined as a leaf node in response to determining that the training node does not satisfy the preset splitting condition, and a weight value of the leaf node is obtained.

In embodiments of the disclosure, if the training node does not satisfy the preset splitting condition, the server can determine the training node as a leaf node, calculate the weight value wⱼ for the leaf node, and store the value of wⱼ as the vertical weight value of the leaf node.

The weight value wⱼ of the leaf node which can be used to calculate a sample prediction score is represented by a following equation:

$${w}_{j}^{*} = - \frac{{G}_{j}}{{H}_{j} + λ} ,$$

where Gⱼ represents a sum of gᵢ corresponding to all instances of node j, and Hⱼ represents a sum of hᵢ corresponding to all instances of node j.

At block S1302, the weight value of the leaf node is sent to each client.

In embodiments of the disclosure, the server can send the weight value of the leaf node to each client after obtaining the weight value of the leaf node to notify each client to stop performing the node splitting on the leaf node in the vertical splitting mode, i.e., the node splitting operation is completed.

It is understandable that in embodiments of the disclosure, before notifying each client to perform the node splitting based on target split mode, split information can be sent to each client. The split information includes the target split mode, a target split feature selected as the feature split point, and the target split value.

As illustrated in FIG. 16, on the basis of the above, if the target split mode is the vertical split mode, before notifying each client to perform, based on the target split mode, the node splitting, the method further includes the following.

At block S1401, the split information is sent to clients having labels.

In embodiments of the disclosure, the server can send the split information to the clients having labels. Correspondingly, the clients having labels can receive the split information and perform the node splitting on the training node based on the split information.

For the vertical splitting mode, optionally, the server can notify each client to perform the node splitting operation based on the recorded vertical split information including “(client_id, record_id, IL, feature_name, feature_value)”. The client corresponding to the client_id knows all the information, i.e., “(client_id, record_id, IL, feature_name, feature_value)”, and other clients only need to know the IL information. The server takes the left subtree node generated by the current splitting as the current processing node.

Correspondingly, the client receives the IL or all the information, i.e., “(client_id, record_id, IL, feature_name, feature_value)” sent by the server, and performs the node splitting operation in the vertical splitting mode. If the information “(client_id. record_id, IL, feature_name, feature_value)” is received, the client also needs to record and store this information during the splitting. After the splitting is completed, the client can use the left subtree node generated by the splitting as the current processing node.

For the horizontal splitting mode, optionally, the server can split the node by adopting the horizontal splitting mode, i.e., the current node is split based on the information “(k, value)” obtained by the horizontal splitting mode, and the IL information can be obtained and broadcasted to each client.

Correspondingly, the clients can receive the information “(k, value)” from the server and perform the node splitting on the data having the common IDs. The splitting mode is for each feature k of data having common IDs, adding an ID of data to the IL if the value of the data for the feature k is less than a threshold “value” and adding the ID to the IR if the value of the data for the feature k is not less than the threshold “value”. In addition, if the data does not have the feature k, the data is added into the right subtree space.

At block S1402, a set of left subtree spaces sent by clients having labels is received.

In embodiments of the disclosure, the clients having labels can send respective left subtree spaces generated by the node splitting to the server after performing the node splitting on the training node. Correspondingly, the server can receive the set of left subtree spaces sent by the clients having labels.

At block S1403, the second training set is split based on the set of left subtree spaces.

At block S1404, the training node is associated with IDs of the clients having labels.

It is understandable that in the disclosure, initialization can be performed before the current training node satisfies the preset splitting condition.

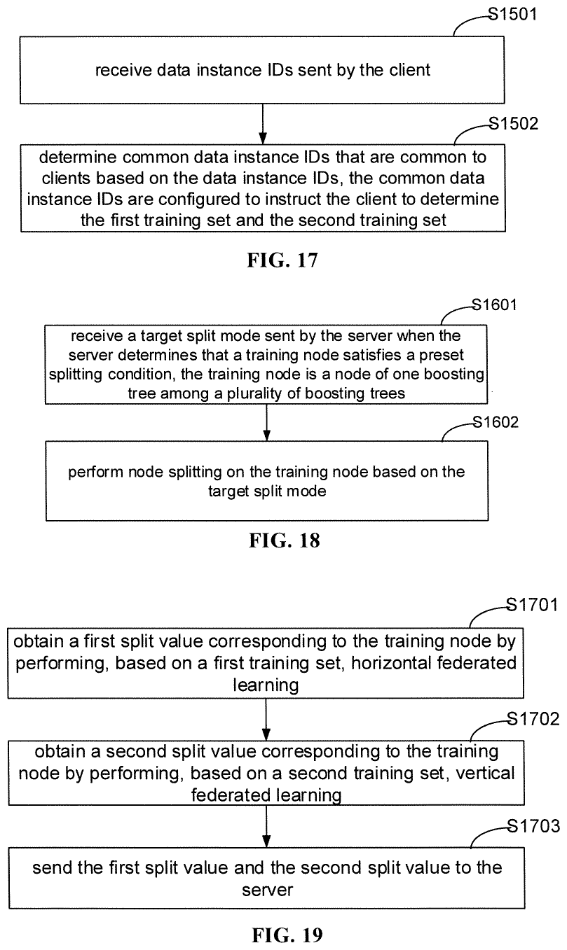

As a possible implementation, as illustrated in FIG. 17, the method includes the following on the basis of the above.

At block S1501, data instance IDs sent by clients are received.

In embodiments of the disclosure, a respective unique ID of each piece of data can be sent by the clients to the server. Correspondingly, the server can receive the respective unique ID, i.e., the data instance ID, of each piece of data.

At block S1502, common data instance IDs that are common to the clients are determined based on the data instance IDs, in which the common data instance IDs are configured to instruct the client to determine the first training set and the second training set.

In embodiments of the disclosure, the server can collect all instance IDs of each client, obtain the common instance IDs among the clients, and notify each client of the common instance IDs. The server can select one client as a verification client, select labeled data from data of the verification client as the verification dataset, in which the selected labeled data does not included in the set of data having the common IDs, modify the list of training datasets corresponding to the selected client and initialize the information of the verification dataset. Each client is notified of the list of verification IDs and the list of common IDs. Correspondingly, each client can receive the list of common IDs and the list of verification IDs (if exists) from the server and initialize the global native data information.

The server can perform information initialization for each round of training for the current XGB forest list and the number of training rounds, perform information initialization for each tree for the current tree node and the current XGB forest list, and notify the client of the initialized information for each round of training or the initialized information for each tree.

After the target federated learning model is obtained, the generated target federated learning model may be verified.

In some examples, the server may verify the target federated learning model in collaboration with the verification client based on a verification set. The verification client is one of the clients involved in the training of the federated learning model. The verification set is mutually exclusive with the first training set and the second training set, respectively.

As a possible implementation, the server can notify the client to perform verification initializing operation. Correspondingly, the client performs the verification initializing operation.

The server can select an ID for starting the verification, initialize the XGB tree, and notify the client to perform the verification. Correspondingly, the client initializes the verification information.

The server can send split node information and the data ID used for the verification to the verification client according to the current tree. Correspondingly, the client can obtain the corresponding data according to the data ID, determine a proceeding direction whether the data should be assigned to the left subtree or the right subtree according to the split node information sent by the server, and return a determination result to the server.

The server can proceed to the next node based on the proceeding direction returned by the client, determine whether the next node is a leaf node, select a new ID to restart the verification process if the next node is not a leaf node, initialize the XGB tree, and notify the client to restart to perform the verification. If the next node is a leaf node, the weight of the leaf node can be recorded, and the prediction value can be calculated and stored. If the current ID for which the prediction value is calculated is not a last one of all predicted IDs, a new ID is selected to restart the verification, the XGB tree is initialized, and the client is notified to start to perform the verification again. If the current ID for which the prediction value is calculated is the last one of all predicted IDs, all the prediction results are sent to the client. Correspondingly, the client can receive all the prediction results to determine the final verification result, and compare the final verification result with a previous verification result to determine whether to keep and use the current model and notify the server of the result.

Based on the verification result returned by the client, the server can determine whether to keep and use the current model, and broadcast the result to all clients. Correspondingly, each client receives the broadcasted information from the server for processing.

The server can determine whether a final round of prediction is reached. If the final round of prediction is not yet reached, the client can perform again the information initialization for the current XGB forest list and the number of training rounds. If the final round of prediction is reached, the client can stop the training, delete the information, and retain the model. Correspondingly, the client stops the training, deletes the information, and retains the model.

Therefore, with the method for training a federated learning model according to the disclosure, the propensity of automatically selecting the matched learning mode is realized by mixing the horizontal splitting mode and vertical splitting mode without considering the data distribution mode, which solves the problems that the training process of the existing federated learning models cannot fully utilize all the data for learning and has poor training results due to insufficient data utilization, reduces the loss of the federated learning model and improves the performance of the federated learning model.

FIG. 18 is a flowchart of another method for training a federated learning model according to an embodiment of the disclosure.

As illustrated in FIG. 18, the method for training a federated learning model according to embodiments of the disclosure is explained and described by taking each of clients as the executing subjects. The method includes the following.

At block S1601, a target split mode sent by the server when the server determines that a training node satisfies a preset splitting condition is received, in which the training node is a node of one boosting tree among a plurality of boosting trees.

In embodiments of the disclosure, if the training node satisfies the preset splitting condition, it means that the current training node needs to be split. In this case, the server can obtain the target split mode corresponding to the training node and inform each client to perform, based on the target split mode, the node splitting. Correspondingly, each client can receive the target split mode sent by the server when the server determines that the training node satisfies the preset splitting condition.

At block S1602, node splitting is performed on the training node based on the target split mode.

In embodiments of the disclosure, the server can determine the target split mode corresponding to the training node based on a first split value and a second split value. Correspondingly, each client can receive the IL or information “(client_id, record_id. IL, feature_name, feature_value)” from the server, and perform the node splitting on the training node according to the target split mode. If the information “(client_id, record_id, IL, feature_name, feature_value)” is received by a client, the client also needs to record and store this information while performing the node splitting on the training node.

After the node splitting is completed, each client can use a left subtree node generated by the node splitting as a current processing node.

Therefore, with the method for training a federated learning model according to embodiments of the disclosure, each client can receive the target split mode sent, when the server determines that the training node satisfies the preset splitting condition, by the server, in which the training node is a node of one boosting tree among a plurality of boosting trees. The node splitting is performed on the training node based on the target split mode. The propensity of automatically selecting a matched learning mode is realized by mixing the horizontal splitting mode and the vertical splitting mode without considering the data distribution mode, which solves the problems that the training process of the existing federated learning models cannot fully utilize all the data for learning and has poor training results due to insufficient data utilization, reduces the loss of the federated learning model and improves the performance of the federated learning model.

It is understandable that in the disclosure, each client can collaborate with the server to perform federated learning and obtain corresponding split values before performing, based on the target split mode, the node splitting on the training node.

As a possible implementation, as illustrated in FIG. 19, on the basis of the above, the method includes the following.

At block S1701, a first split value corresponding to the training node is obtained by performing, based on a first training set, horizontal federated learning.

It is understandable that in the disclosure, in obtaining the first split value corresponding to the training node by performing, based on the first training set, the horizontal federated learning, an initial set of data instance IDs corresponding to the training node can be obtained and sent to the server.

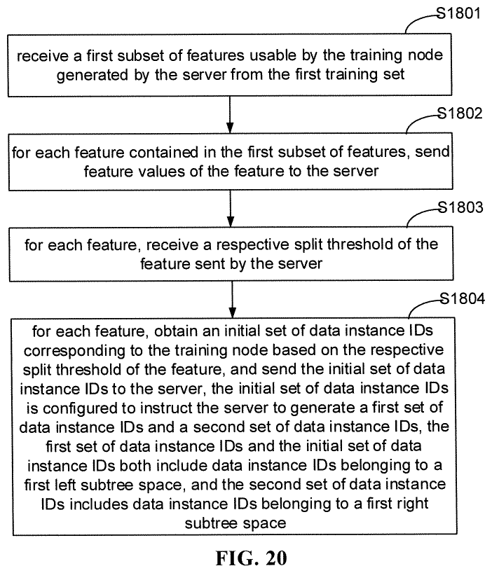

As a possible implementation, as illustrated in FIG. 20, on the basis of the above, the method includes the following.

At block S1801, a first subset of features usable by the training node generated by the server from the first training set is received.

In embodiments of the disclosure, the server can randomly generate, from the first training set, the first subset of features that is usable by the current training node. For example, the server can randomly select half of features in the current first training set to form a new feature set as the first subset of features and send the generated first subset of features to each client. Correspondingly, each client can receive the first subset of features.

At block S1802, a respective feature value of each feature included in the first subset of features is sent to the server.

In embodiments of the disclosure, for each feature included in the first subset, each client can obtain all feature values of the feature through traversal, randomly select one from the obtained feature values of the feature based on native data, i.e., the feature values of each natively-stored feature, and send the selected feature value to the server. Correspondingly, the server collects, for the current feature, the respective feature value sent by each client to form a list of feature values, randomly selects one from the list as a global optimal split threshold of the current feature, and broadcasts the global optimal split threshold to each client.

At block S1803, a respective split threshold of each feature sent by the server is received.

In embodiments of the disclosure, for each feature included in the first subset of features, the server can determine the respective split threshold of the feature based on the received feature values of the feature and send the respective split threshold to each client. Correspondingly, each client can receive the respective split threshold of the feature sent by the server.

At block S1804, for each feature, an initial set of data instance IDs corresponding to the training node is obtained based on the respective split threshold value of the feature and sent to the server, in which the initial set of data instance IDs is configured to instruct the server to generate a first set of data instance IDs and a second set of data instance IDs, the first set of data instance IDs includes data instance IDs belonging to a first left subtree space, the initial set of data instance IDs includes data instance IDs belonging to a first left subtree space, and the second set of data instance IDs includes data instance IDs belonging to a first right subtree space.

In embodiments of the disclosure, in obtaining, for each feature, the initial set of data instance IDs corresponding to the training node based on the respective split threshold of the feature, the respective split threshold of the feature is compared with values of data instances for the feature respectively to determine the data instance IDs of data instances whose values for the feature are less than the respective split threshold to form the initial set of data instance IDs. The split threshold can be set before starting the training according to the actual situation.

As a possible implementation, each client can perform the node splitting for the current feature according to the received information of the split threshold corresponding to the feature, to obtain the IL, and notify the server of the IL. If the data instances of a client do not have the feature, an empty set is returned by the client as the IL.

The IL is a set of instance IDs of the left subtree space. The way of calculating the IL is: receiving the threshold represented by “value” corresponding to the feature k from the server, and adding the ID1 into the IL if the value of an instance ID1 included in the native data for feature k is less than the threshold “value”, which is represented by the equation:

S_{IL}={ID|ID^{k}<value},

where ID^{k} represents the value of the instance ID for the feature A, and S_{IL} represents the IL.

At block S1702, a second split value corresponding to the training node is obtained by performing, based on a second training set, vertical federated learning.

It is understandable that in the disclosure, before obtaining the second split value corresponding to the training node by performing, based on the second training set, the vertical federated learning, respective first gradient information of at least one third set of data instance IDs can be obtained and the respective first gradient information of the at least one third set of data instance IDs is sent to the server.

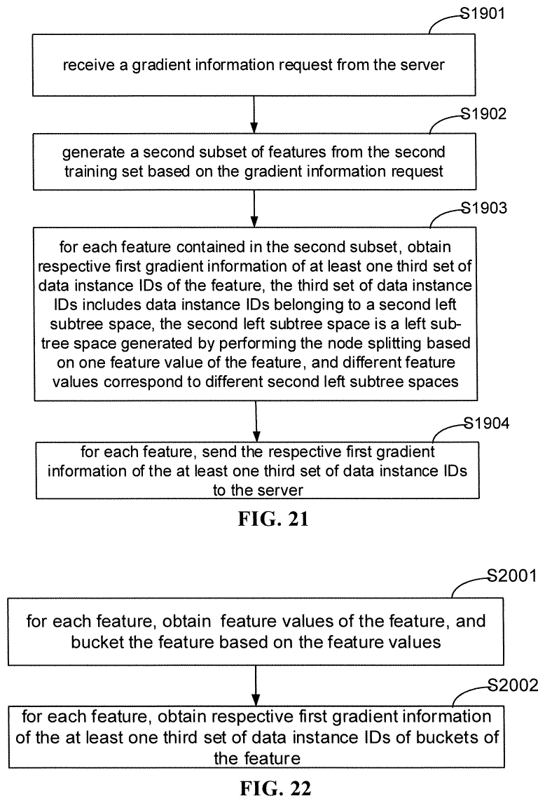

As a possible implementation, as illustrated in FIG. 21, on the basis of the above, the method includes the following.

At block S1901, a gradient information request is received from the server.

In embodiments of the disclosure, the server can send the gradient information request to each client to request the Gkv and Hkv information. Correspondingly, each client can receive the gradient information request from the server.

At block S1902, a second subset of features is generated from the second training set based on the gradient information request.

At block S1903, for each feature included in the second subset of features, respective first gradient information of at least one third set of data instance IDs of the feature is obtained, in which the third set of data instance IDs includes data instance IDs belonging to a second left subtree space, the second left subtree space is a left subtree space generated by performing the node splitting according to one feature value of the feature, and different feature values correspond to different second left subtree spaces.

As a possible implementation, as illustrated in FIG. 22, on the basis of the above, the method includes the following.

At block S2001, for each feature, all feature values of the feature are obtained, and the bucket mapping is performed for the feature based on the feature values.

In embodiments of the disclosure, for each feature k included in the second subset, the bucket mapping is performed on each sample based on the feature k and a respective value v of each sample for the feature.

It is understandable that there are many bucket mapping rules, and the specific bucket mapping rule adopted in the disclosure is not limited, as long as ensuring that samples having the same value for the feature, such as two samples having the same value, e.g., 1, for the feature in FIG. 11, are divided in the same data bucket.

For example, the samples, i.e., n sample, having the same value for the feature can be divided into one bucket, and if a feature have m feature values, the samples are divided into m buckets, and the corresponding feature thresholds are these m values.

For example, the number of buckets can be limited, for example, there are m buckets at most. In this case, if the number of values for this feature k is less than m, the samples can be divided according to the previous mode. If the number of values for this feature k is greater than m, the samples can be divided into m buckets according to the approximate equal division method.

At block S2002, for each feature, respective first gradient information of a third set of data instance IDs corresponding to each bucket is obtained.

In embodiments of the disclosure, each client can obtain respective first gradient information of the third set of data instance IDs corresponding to each bucket of the feature. Correspondingly, the server can receive the first gradient information of the at least one third set of data instance IDs of each feature sent by each client.

At block S1904, the respective first gradient information of each third set of data instance IDs is sent to the server.

In embodiments of the disclosure, each client can obtain data that has not been processed yet at the current node based on data of common IDs to randomly form a feature set, and perform bucket mapping on each sample based on each feature k included in the feature set and a respective value v of each sample for the corresponding feature k, to calculate the Gkv and Hkv of the left subtree space. The homomorphic encryption processing is performed on the Gkv and Hkv and the processed Gkv and Hkv are sent to the server.

At block S1703, the first split value and the second split value are sent to the server.

In embodiments of the disclosure, after each client performs the horizontal federated learning and the vertical federated learning based on the first training set and the second training set, to obtain the second split value corresponding to the training node, and the first split value and the second split value can be sent to the server. Correspondingly, the server can receive the first split value and the second split value.

It is understandable that in the disclosure, for performing node splitting on the training node based on the target split mode, the node splitting can be performed based on split information sent by the server.

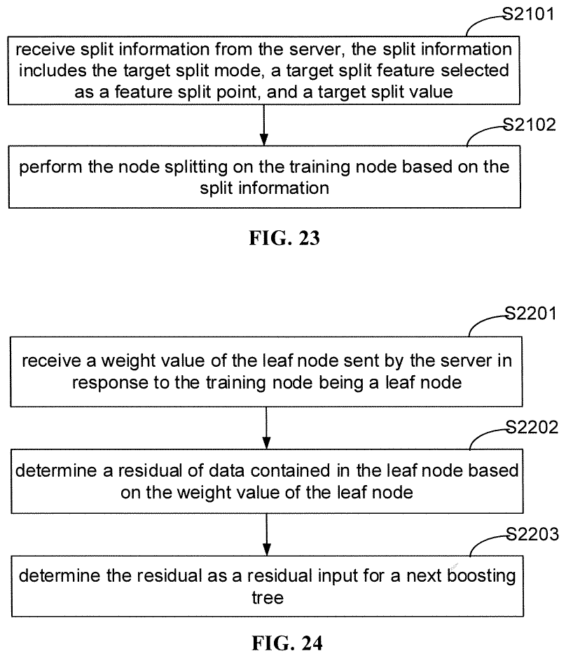

As a possible implementation, as illustrated in FIG. 23, on the basis of the above, the method includes the following.

At block S2101, split information is received from the server, in which the split information includes the target split mode, a target split feature selected as a feature split point, and the target split value.

In embodiments of the disclosure, before notifying the clients to perform, based on the target split mode, the node splitting, the server can send the split information to each client. The split information includes the target split mode, the target split feature selected as feature split point and the target split value. Correspondingly, each client can receive the split information from the server.

As a possible implementation, the server can split the node by adopting the horizontal splitting mode, i.e., the current node is split according to the information “(k, value)” obtained by the horizontal splitting mode to obtain the IL information and broadcast the IL information to each client.

At block S2102, the node splitting is performed on the training node based on the split information.

As a possible implementation, each client can perform node splitting on the data having the common IDs based on the received information “(k, value)” from the server. The splitting mode is for each feature k of data having common IDs, adding an ID of data to the IL if the value of the data for the feature k is less than a threshold “value” and adding the ID to the IR if the value of the data for the feature k is not less than the threshold “value”. In addition, if the data does not have the feature k, the data is added into the right subtree space.

After performing the node splitting on the training node, each client can send the left subtree space generated by the node splitting to the server. Correspondingly, the server can receive the left subtree space generated by the node splitting.

It is understandable that, in embodiments of the disclosure, if the training node satisfies the preset splitting condition, it means that the training node needs to be split. If the training node does not satisfy the preset splitting condition, it means that the training node does not need to be split. In this case, the clients can use a residual as a residual input of a next boosting tree, while performing node backtracking.

As a possible implementation, as illustrated in FIG. 24, on the basis of the above, the method includes the following.

At block S2201, in response to the training node being a leaf node, a weight value of the leaf node sent by the server is received.

In embodiments of the disclosure, if the training node does not satisfy the preset splitting condition, the server can take the current node as a leaf node, calculate the weight value wⱼ for the leaf node, and store the value of wⱼ as the vertical weight value of the leaf node. Correspondingly, each client can receive the weight value wⱼ of the leaf node from the server.

At block S2202, a residual is determined for the data contained in the leaf node based on the weight value of the leaf node.

At block S2203, the residual is determined as a residual input for the next boosting tree.

In embodiments of the disclosure, each client can calculate a new y′(t−1)(i) based on [Ij(m), wⱼ] and backtrack to another non-leaf node of the current tree as the current node, in which, y′(t−1)(i) represents the Label residual corresponding to the i^{th} instance, t represents the current tree, i.e., the t^{th} tree, and (t−1) represents the previous tree.

Therefore, with the method for training a federated learning model according to the disclosure, each client can receive the target split mode from the server when the server determines that the training node satisfies the preset splitting condition. The training node is a node of one boosting tree among the plurality of boosting trees. The node splitting is performed on the training node based on the target split mode. The propensity of automatically selecting a matched learning mode is realized by mixing the horizontal splitting mode and the vertical splitting mode, without considering the data distribution mode, which solves the problems that the training process of the existing federated learning models cannot fully utilize all the data for learning and has poor training results due to insufficient data utilization, reduces the loss of the federated learning model and improves the performance of the federated learning model.

It is understandable that in embodiments of the disclosure, the training process of the federated learning model mainly includes several stages, such as a node splitting stage, a model generation stage, and a model verification stage. The following is an explanation of the method for training a federated learning model according to the disclosure with the server as the executing subject and the verification client as the executing subject respectively when the training process includes the stages of node splitting, model generation, and model verification.

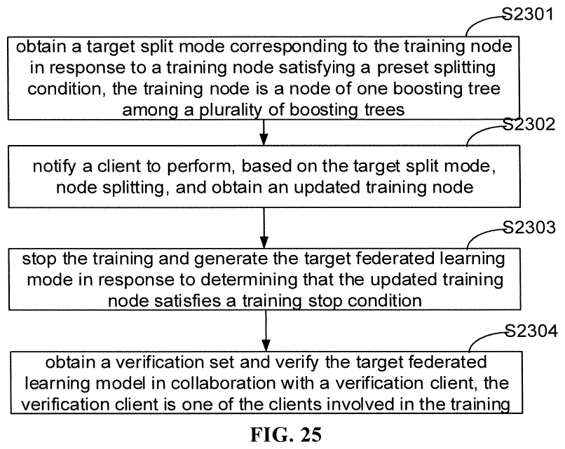

If the server is the executing subject, as illustrated in FIG. 25, the method for training a federated learning model according to embodiments of the disclosure includes the following.

At block S2301, in response to a training node satisfying a preset splitting condition, a target split mode corresponding to the training node is obtained, in which the training node is a node of one boosting tree among a plurality of boosting trees.

At block S2302, clients are notified to perform, based on the target split mode, node splitting.

At block S2303, in response to determining that an updated training node satisfies a training stop condition, the training is stopped and the target federated learning model is generated.

It is understandable that the relevant contents of blocks S2301 to S2303 can be referred to the above-mentioned embodiments and will not be repeated here.

At block S2304, a verification set is obtained and the target federated learning model is verified in collaboration with a verification client, in which the verification client is one of the clients involved in the training of the federated learning model.

The verification set is typically a portion of samples in the training set. In an example, the verification set may include a preset ratio of samples randomly selected from the training set. In embodiments of the disclosure, the verification set includes data instance IDs, and the verification set is mutually exclusive with the first training set and the second training set, respectively.

Therefore, with the method for training a federated learning model according to the disclosure, after generating the federated learning model, the server can obtain the verification set and collaborate with the verification client to verify the target federated learning model, so that when there are more homogeneous user data, a manner of combining the training and the verification is adopted to reduce the verification loss of the federated learning model, improve the inference effect of the federated learning model, and further improve the validity and reliability of the training process of the federated learning model.

It is understandable that in embodiments of the disclosure, the updated training node is one selected from a group including the left subtree node generated by splitting the training node and other non-leaf nodes of the boosting tree. The updated training node satisfying the training stop condition means that the updated training node does not satisfy the preset splitting condition, or the updated training node is a last node of the plurality of boosting trees.

It is understandable that in embodiments of the disclosure, for obtaining the verification set and collaborating with the verification client to verify the target federated learning model, the data instance IDs in the verification set can be verified one by one until all the data instance IDs in the verification set are verified.

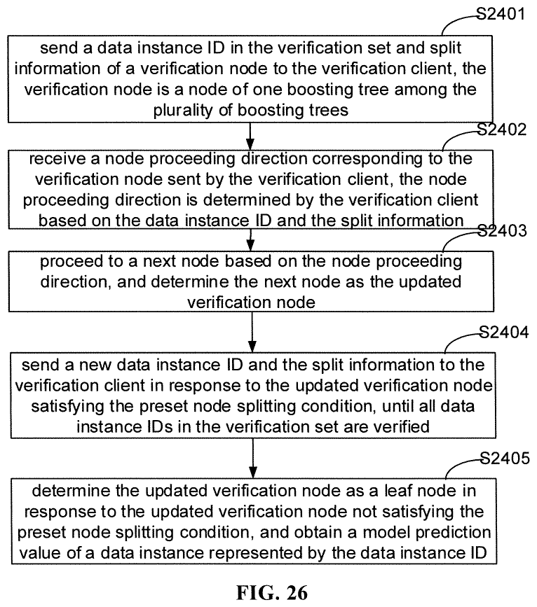

As a possible implementation, as illustrated in FIG. 26, based on the above, the process of obtaining the verification set and collaborating with the verification client to verify the target federated learning model at the above block S2304 includes the following.

At block S2401, a data instance ID included in the verification set and split information of a verification node are sent to the verification client, in which the verification node is a node of one boosting tree among the plurality of boosting trees.

In embodiments of the disclosure, the server can send any data instance ID to the verification client, and send the split information of the verification node simultaneously to the verification client. Correspondingly, the verification client can receive the data instance ID and the split information of the verification node, obtain the corresponding data according to the data instance ID, and determine a node proceeding direction corresponding to the verification node according to the split information, i.e., determine whether the node proceeding direction is to the left subtree or to the right subtree.

The split information includes a feature used for splitting and a split threshold.

At block S2402, the node proceeding direction corresponding to the verification node sent by the verification client is received, in which the node proceeding direction is determined by the verification client based on the data instance ID and the split information.

In embodiments of the disclosure, the verification client can send the node proceeding direction to the server after determining the node proceeding direction corresponding to the verification node. Correspondingly, the server can receive the node proceeding direction corresponding to the verification node from the verification client.

At block S2403, the server proceeds to the next node based on the node proceeding direction, and the next node is determined as the updated verification node.

In embodiments of the disclosure, the server can proceed to the next node according to the node proceeding direction returned by the verification client, and determine the next node as the updated verification node. The server can determine whether the updated verification node satisfies the preset node splitting condition. If the updated verification node satisfies the preset node splitting condition, it means that the updated verification node is not a leaf node, then the block S2404 can be executed. If the updated verification node does not satisfy the preset node splitting condition, it means that the updated verification node is a leaf node, then the block S2405 can be executed.

At block S2404, in response to the updated verification node satisfying the preset node splitting condition, the data instance ID and the split information are sent to the verification client until all data instance IDs in the verification set are verified.

At block S2405, in response to the updated verification node not satisfying the preset node splitting condition, the updated verification node is determined as a leaf node, and a model prediction value of a data instance represented by the data instance ID is obtained.

In embodiments of the disclosure, the server can record the weight value of the leaf node after determining that the updated verification node is a leaf node, and calculate and store the model prediction value of the data instance represented by the data instance ID.

The model prediction value of the data instance represented by the data instance ID refers to a prediction value of the sample. During verification, when a sample goes to a certain leaf node on a tree, the leaf score of that leaf node is the score of the sample on this tree, and thus the sum of the scores of the sample on all trees is the prediction value.

After completing the block S2404 above, it can be determined whether to reserve and use the target federated learning model.

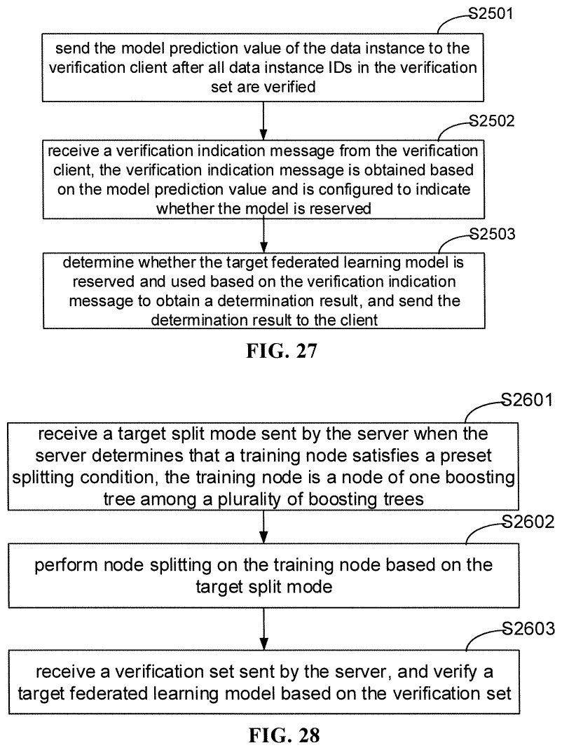

As a possible implementation, as illustrated in FIG. 27, on the basis of the above, after the block S2404, the method includes the following.

At block S2501, the model prediction values of the data instances are sent to the verification client after all data instance IDs in the verification set are verified.

In embodiments of the disclosure, if all data instance IDs in the verification set are verified, i.e., the currently predicted data instance ID is the last of all the predicted data instance IDs, then the model prediction values of the data instances can be sent to the verification client. Correspondingly, the verification client receives all prediction results, calculates a final verification result, compares the final verification with a previous verification result to determine whether to reserve and store the current target federated learning model, and generates a verification indication message based on the determination result.

It is understandable that the client can calculate the prediction values for all samples in the verification set in generating the verification indication message. Since the verification client has ground truth values (labeled values) of the samples, in this case the client can calculate relevant difference indicators, such as accuracy or Root Mean Squared Error (RMSE), between the prediction values and the labeled values, and determine the performance of the model in a current Epoch based on the aforementioned indicators.

The current Epoch, also known as a current cycle of training, means all training samples passing through the neural network for one cycle including a forward pass and a backward pass. That is, an Epoch is training the neural network with all the training data for one cycle. The current model can be kept if a relevant difference indicator obtained is better than that of the previous Epoch, and the current model can be discarded if a relevant difference indicator obtained is worse than that of the previous Epoch.

At block S2502, a verification indication message is received from the verification client, in which the verification indication message is an indication message obtained based on the model prediction value, for indicating whether the model is reserved.

In embodiments of the disclosure, the verification client can send the verification indication message to the server. Correspondingly, the server can receive the verification indication messages from the verification client.

At block S2503, it is determined whether the target federated learning model is reserved and used based on the verification indication message to obtain a determination result, and the determination result is sent to the clients.

In embodiments of the disclosure, the server can determine whether to reserve and use the target federated learning model based on the verification indication message, and send the determination result to all clients.

If the verification client is the execution subject, as illustrated in FIG. 28, the method for training a federated learning model according to the disclosure includes the following.

At block S2601, a target split mode sent by the server when the server determines that a training node satisfies a preset splitting condition is received, in which the training node is a node of one boosting tree among a plurality of boosting trees.

At block S2602, node splitting is performed on the training node based on the target split mode.

It is understandable that the relevant contents of blocks S2601 to S2602 can be referred to the above-mentioned embodiments and will not be repeated here.

At block S2603, a verification set sent by the server is received, and a target federated learning model is verified based on the verification set.

In embodiments of the disclosure, the server can obtain the verification set and send it to the verification client. Correspondingly, the verification client can receive the verification set from the server and verify the target federated learning model based on the verification set.

The verification set sent by the server is received, and the target federated learning model is verified based on the verification set.

With the method for training a federated learning model according to the disclosure, after performing the node splitting on the training node based on the target split mode, the verification client can receive the verification set sent by the server and verify the target federated learning model based on the verification set. Therefore, when there are more homogeneous user data, a manner of combining the training and the verification is adopted to reduce the verification loss of the federated learning model, improve the inference effect of the federated learning model, and further improve the validity and reliability of the training process of the federated learning model.

It is understandable that in embodiments of the disclosure, for verifying the target federated learning model by the verification client based on the verification set, the verification client can verify the data instance IDs in the verification set one by one until all the data instance IDs in the verification set are verified.

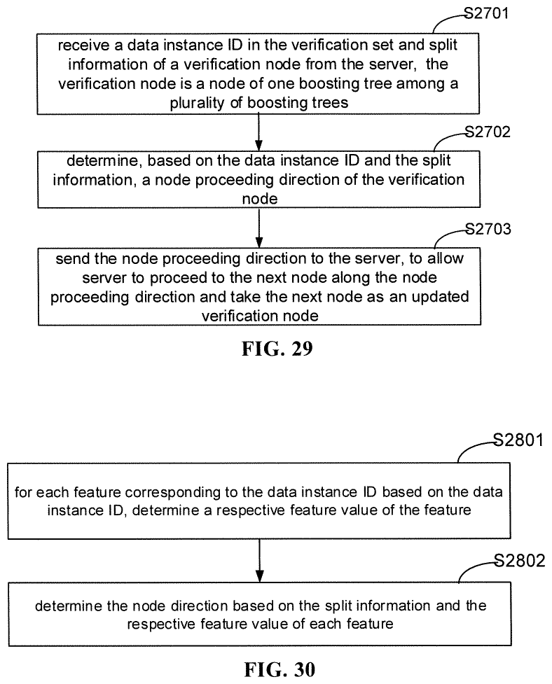

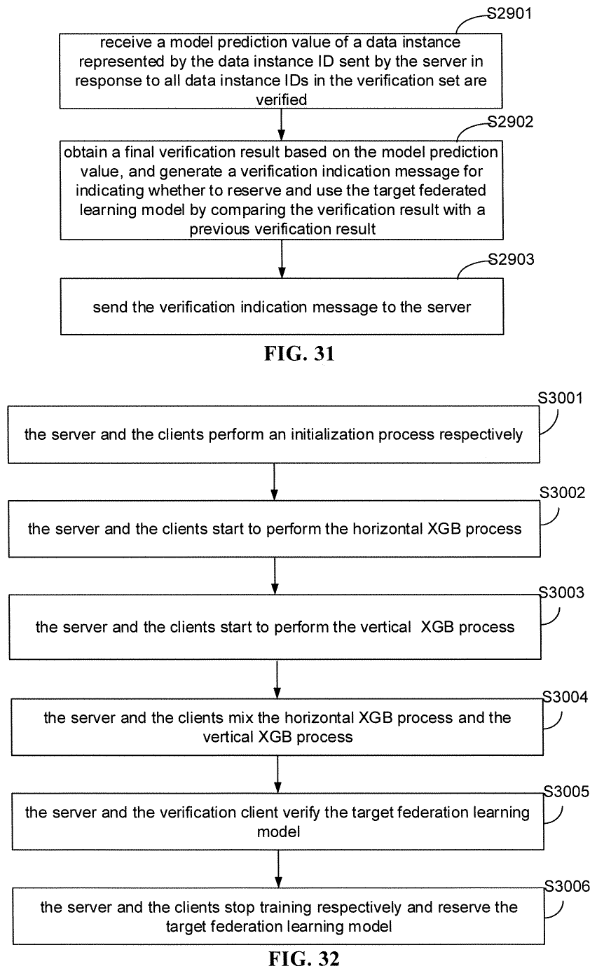

As a possible implementation, as illustrated in FIG. 29, on the basis of the above, the process of verifying the target federated learning model based on the verification set in the above block S2603 includes the following.

At block S2701, a data instance ID included in the verification set and split information of a verification node are received from the server, in which the verification node is a node of one boosting tree among a plurality of boosting trees.

In embodiments of the disclosure, the server can send any data instance ID to the verification client, along with the split information of the verification node. Correspondingly, the verification client receives the data instance ID and the split information of the verification node.

The split information includes a feature used for splitting and a split threshold.

At block S2702, a node proceeding direction corresponding to the verification node is determined based on the data instance ID and the split information.

In embodiments of the disclosure, the verification client can obtain the corresponding data according to the data instance ID, and determine the node proceeding direction corresponding to the verification node based on the split information, i.e., determine whether the node proceeding direction is to the left subtree or to the right subtree.

As a possible implementation, as illustrated in FIG. 30, the process of determining the node proceeding direction of the verification node based on the data instance ID and the split information in the block S2702 includes the following.

At block S2801, based on the data instance ID, for each feature corresponding to the data instance ID, a respective feature value of the feature is determined.

It is understandable that the relevant contents of block S2801 can be referred to the above-mentioned embodiments and will not be repeated here.

At block S2802, the node proceeding direction is determined based on the split information and the respective feature value of each feature.

In embodiments of the disclosure, the verification client can determine the feature used for splitting based on the split information and determine the node proceeding direction based on the respective feature value of each feature and the split threshold.

At block S2703, the node proceeding direction is sent to the server, to allow the server to proceed to the next node along the node proceeding direction and take the next node as the updated verification node.

In embodiments of the disclosure, the verification client can send the node proceeding direction to the server after determining the node proceeding direction of the verification node. Correspondingly, the server can receive the node proceeding direction corresponding to the verification node from the verification client.

After completing the above block S2703, it is determined whether to reserve and use the target federated learning model.

As a possible implementation, as illustrated in FIG. 27, on the basis of the above, after the block S2703, the method includes the following.

At block S2901, in response to determining that all data instance IDs in the verification set are verified, model prediction values of data instances represented by the data instance IDs sent by the server are received.

In embodiments of the disclosure, if all data instance IDs in the verification set are verified, i.e., the currently predicted data instance ID is the last of all predicted data instance IDs, then the model prediction values of the data instances can be sent to the verification client. Correspondingly, the verification client receives all prediction results, calculates a final verification result, compares the final verification with a previous verification result to determine whether to reserve and store the current target federated learning model, and generates a verification indication message based on the determination result.

It is understandable that the verification client can calculate the prediction values for all samples in the verification set in generating the verification indication message. Since the verification client has ground truth values (labeled values) of the samples, in this case the client can calculate relevant difference indicators, such as accuracy or Root Mean Squared Error (RMSE), between the prediction values and the labeled values, and determine the performance of the model in a current Epoch based on the aforementioned indicators.

The current Epoch, also known as a current cycle of training, means all training samples passing through the neural network for one cycle including a forward pass and a backward pass. That is, an Epoch is training the neural network with all the training data for one cycle. The current model can be kept if a relevant difference indicator obtained is better than that of the previous Epoch, and the current model can be discarded if a relevant difference indicator obtained is worse than that of the previous Epoch.

At block S2902, a final verification result is obtained based on the model prediction values, and a verification indication message for indicating whether to reserve and use the target federated learning model is generated by comparing the verification result with a previous verification result.

In embodiments of the disclosure, the verification client can send the verification indication message to the server. Correspondingly, the server can receive the verification indication message from the verification client.

At block S2903, the verification indication message is sent to the server.

In embodiments of the disclosure, the server can determine whether to reserve and use the target federated learning model based on the verification indication message sent by the verification client, and send the determination result to all clients.

FIG. 32 is a flowchart of a method for training a federated learning model according to an embodiment of the disclosure.

As illustrated in FIG. 32, taking the XGB as an example, the method for training a federated learning model according to the disclosure is described and explained based on the whole process of training the federated learning model using the server and clients (including the verification client). The method includes the following.

At block S3001, the server and the clients start an initialization process respectively.

For example, each client sends data IDs to the server. In detail, each client sends unique data IDs of all data to the server. The data ID is used to uniquely distinguish each piece of data. Correspondingly, the server receives the data IDs sent by each client.

The server determines the common data IDs among the clients based on the received data IDs. The common data IDs are those both-owned among different clients that are identified by the server based on the data IDs reported by each client.

The server sends the common data IDs to each client.

Each client obtains derivatives of the loss equation based on the common data IDs and the native data, and performs homomorphic encryption on the obtained derivatives. In detail, each client can calculate some intermediate results of the loss function, such as the first-order derivative gi and the second-order derivative hi of the loss function, based on the common data IDs and the native data. The first-order derivative gi and the second-order derivative hi are calculated through following equations:

gᵢ=∂_{ŷ}_{^{(t−1)}}l(yᵢ,ŷ^{(t-1)}, hᵢ=∂_{ŷ}_{ᵢ}_{^{(t−1)}}²l(yᵢ,ŷ^{(t-1)}),

where yᵢ is a prediction result of an sample i, and the meaning of each symbol can be refer to the related art.

The loss function is represented by a following equation:

$${L}^{( t )} = {\sum }_{i = 1}^{𝔫} [ {g}_{i} {f}_{t} ( {x}_{i} ) + \frac{1}{2} {h}_{i} {f}_{t}^{2} ( {x}_{i} ) ] + Ω ( {f}_{t} ) .$$

An approximate representation of the above equation using a second-order Taylor expansion is proposed in XGB. The second order form of the Taylor expansion is given by:

$${L}^{( t )} ≃ {\sum }_{i = 1}^{𝔫} [ l ( {y}_{i} , {\hat{y}}_{i}^{( t - 1 )} ) + {g}_{i} {f}_{t} ( {x}_{i} ) + \frac{1}{2} {h}_{i} {f}_{t}^{2} ( {x}_{i} ) ] + Ω ( {f}_{t} ) + constant ,$$

Each client sends the encrypted derivatives to the server. Correspondingly, the server receives the encrypted derivatives from each client.

The server decrypts the received encrypted derivatives and averages the decrypted derivatives, to obtain average values respectively. For the same common data ID, the derivatives corresponding to each client are accumulated and then averaged. For example, the calculation process can refer to the above descriptions. The first-order derivative gi and the second-order derivative hi corresponding to each of the common data IDs are accumulated and averaged, respectively:

$${g}_{i} = \frac{1}{n} * {\sum }_{i = 1}^{n} ( {g}_{i} ( j ) ) ,$$

$${h}_{i} = \frac{1}{n} * {\sum }_{j = 1}^{n} ( {h}_{i} ( j ) ) ,$$

where n represents the number of common data IDs, g,(j) represents the first-order derivative gᵢ of data j, and hᵢ(j) represents the second-order derivative hᵢ of data j.

The server sends the average values to each client. For example, the server sends the average values to each client in the form of a list. In an implementation, the first-order derivative gᵢ and the second-order derivative hᵢ are both included in the same list. In another implementation, the first-order derivative gᵢ and the second-order derivative hᵢ are included in separate lists. For example, the first-order derivative gᵢ is in list A and the second-order derivative hᵢ is in list B. Correspondingly, each client receives the average values sent by the server.

The client updates the natively-stored average values.

At block S3002, the server and the clients perform the horizontal XGB processing.

For example, the server determines whether a current tree node needs to be split. For example, the server determines whether the tree node needs to be split by determining whether the level of the current tree node reaches a maximum tree depth. If the tree node does not need to be split, the server takes the current node as a leaf node, calculates the weight value wⱼ for this leaf node, stores the value of wⱼ as the weight value of the leaf node in the horizontal XGB. If the tree node needs to be split, the server randomly selects features usable by the current node from all features to form a feature set and sends this feature set to each client.

The server randomly selects features usable by the current node from all features to form a feature set and sends this feature set to each client.

Each client traverses through the feature set to obtain features after receiving the feature set and for each feature, randomly selects one of values of native data for the feature and send the selected one value for each feature to the server.

The server collects, for each feature, the value sent by each client to form a list of values, randomly selects one from the list of values as a global optimal split threshold value for the feature, and broadcasts this global optimal split threshold value to each client.

Based on the received global optimal split threshold value, each client performs the node splitting on the current feature to obtain an IL, and notifies the server of the IL. If the native data of a client does not have this feature, an empty set is returned by this client as the IL.

The IL is the set of instance IDs of the left subtree space. In detail, for each feature k, each client receives the global optimal split threshold value of the feature k from the server, if the value of an instance included in the native data for the feature k is less than the global optimal split threshold value, the instance ID1 of this instance is added to the IL set. The IL is represented by a following equation:

S_{IL}={ID|ID^{k}<value},

where ID^{k} represents the value of an instance ID for the feature k, and S_{IL} represents the IL.

For the current feature, the server receives the IL sent by each client, filters out repeated instance IDs from each IL, and processes contradictory ID information. For example, an instance ID of a client will be added to the IL, but an instance ID of another client does not added to the IL; at this time, it is considered that this instance ID of another client should be included in the IL. Thus, the final IL and IR can be determined. If the current feature does not exist in the data of a certain client, the data instance ID of this client will be put into the IR. The, the GL, GR and HL, HR are calculated, and the split value “Gain” of the current feature is calculated and obtained as follows:

$$Gain = \frac{1}{2} [ \frac{{G}_{L}^{2}}{{H}_{L} + λ} + \frac{{G}_{R}^{2}}{{H}_{R} + λ} - \frac{{( {G}_{L} + {G}_{R} )}^{2}}{{H}_{L} + {H}_{R} + λ} ] - γ ,$$

where, GL is the sum of all first-order derivatives gᵢ in the left subtree space, GR is the sum of all first-order derivatives gᵢ in the right subtree space, HL is the sum of all second-order derivatives h, in the left subree space, and HR is the sum of all second-order derivatives hᵢ in the right subtree space, which are represented by following equations:

$${G}_{L} = {\sum }_{j = 1}^{n 1} ( {g}_{i} ( j ) ) , {G}_{R} = {\sum }_{j = 1}^{n 2} ( {g}_{i} ( j ) ) ,$$

$${H}_{L} = {\sum }_{j = 1}^{n 1} ( {h}_{i} ( j ) ) , {H}_{R} = {\sum }_{j = 1}^{n 2} ( {h}_{i} ( j ) ) ,$$

where, n₁ represents the number of instances in the left subtree space, and n₂ represents the number of instances in the right subtree space.

The server, in collaboration with the clients, traverses through each feature in the randomly generated feature set, calculates a respective split value based on each feature as a split node, and determines the feature with the largest split value as the optimal split feature of the current node. Meanwhile, the server also knows the threshold information corresponding to the split node, and uses the split threshold, the split value “Gain”, and the selected feature as the optimal split information of the current node for the horizontal XGB.

The server performs the cleanup operation after performing the horizontal node splitting, and notifies each client to stop the horizontal node splitting operation. That is, the horizontal node splitting operation is completed.

The server takes the node as a leaf node, calculates the weight value wⱼ of the leaf node, and stores the value of wⱼ as the weight value of the leaf node in the horizontal XGB, the weight value is represented by:

$${w}_{m}^{*} = \frac{{G}_{m}}{λ + {H}_{m}} ,$$

where Gₘ represents the sum of gᵢ corresponding to all instances of node m, and Hₘ represents the sum of hᵢ corresponding to all instances of node m.

The server notifies each client to stop the horizontal node splitting operation. That is, the server notifies each client to complete the horizontal node splitting operation.

Each client performs the processing after completing the horizontal node splitting.

At block S3003, the server and the clients perform a vertical XGB processing.

For example, the server notifies each client to perform the vertical XGB processing.

The server requests for Gₖᵥ and Hₖᵥ information from each client.

Each client obtains data that has not been processed yet at the current node based on data of common IDs to randomly form a feature set, and perform bucket mapping on each sample based on each feature k included in the feature set and a respective value v of each sample for the corresponding feature k, to calculate the Gₖᵥ and Hₖᵥ information of the left subtree space. The homomorphic encryption processing is performed on the Gₖᵥ and Hₖᵥ information and the processed Gₖᵥ and Hₖᵥ information is sent to the server. For example, the bucket mapping operation can be performed after ranking the values of the dataset for the feature k to obtain following buckets {s_{k,1}, s_{k,2}, s_{k,3}, . . . s_{k,v-1}}. The Gₖᵥ and Hₖᵥ are calculated as follows:

Gₖᵥ=Σi∈{i|s_{k,v}≥x_{i,k}>s_{k,v-1}} [symbol] gᵢ [symbol] ,

Hₖᵥ=Σi∈{i|s_{k,v}≥x_{i,k}>s_{k,v-1}},

where, x_{i,k} represents the value of data xᵢ for the feature k.

The server decrypts the [[Gₖᵥ]] and [[Hₖᵥ]] sent by each client and can calculate the G and H of the current node based on data having the common data IDs of the current node and all the gᵢ and hᵢ. For example, if some clients have the same feature, the server will randomly select one of the received Gₖᵥ as the Gₖᵥ of the current feature, and Hₖᵥ is processed in the same way. The respective optimal splitting point of each feature can be calculated based on G, H and Gₖᵥ, Hₖᵥ, and the global optimal splitting point “(k, v, Gain)” can be determined based on the aforementioned splitting point information.

In embodiments of the disclosure, the received information can be compared with the preset threshold. If Gain is less than or equal to the threshold, the vertical node splitting is not performed and then the block S3027 is executed. If Gain is greater than the threshold, the block S3023 is executed.

The server requests for the IL from each client based on “(k, v, Gain)”.

If a client C receives the splitting point information “(k, v, Gain)”, the client C finds the splitting point threshold represented by “value”, and records the information “(k, value)” of the splitting point. The native dataset is split according to this splitting point to obtain the IL, and the client C sends “(record, IL, value)” to the server, in which “record” represents the index of the recorded information in the client, and the way of calculating the IL has been described above.

The server accepts the “(record, IL, value)” information sent by Client C, splits all the instances having the common IDs in the node space, and associates the current node with Client C through “(client id, record)”. In embodiments of the disclosure, the server can record “(client id, record_id, IL, feature_name, feature_value)” as the vertical split information and execute the block S3027.

The server takes the current node as a leaf node, calculates the weight value wⱼ for this leaf node, and stores this wⱼ as the vertical weight value of the leaf node.

The server notifies each client to stop to perform the vertical node splitting on the leaf node. In other words, the node splitting operation is completed.

Each client performs the processing after completing the vertical node splitting.

At block S3004, the server and the clients perform a mixed operation of the horizontal XGB process and the vertical XGB process.

For example, the server determines whether the current node needs to be split. In embodiments of the disclosure, if the current node does not need to be split, the server determines that the current node is a the leaf node, calculates the weight value wⱼ for the leaf node, and sends a message [Ij(m), wⱼ] to all clients. If the current node needs to be split, the server obtains a Gain by performing the horizontal XGB and a Gain by performing the vertical XGB, determines a target Gain based on these Gains, and determines the node splitting mode for performing the node splitting.

The server determines the target Gain based on the Gain obtained by performing the horizontal XGB and the Gain obtained by performing the vertical XGB, and determines the node splitting mode for performing the node splitting. In embodiments of the disclosure, if the node splitting mode is the horizontal XGB mode, the server performs the node splitting based on the horizontal XGB mode. That is, the current node is split according to the information (k, value) obtained from the horizontal mode described above to obtain the IL information, and the IL is broadcasted to each client. If the node splitting mode is the vertical XGB mode, each client is notified to perform the node splitting operation based on the vertical splitting information “(client_id, record_id, IL, feature_name, feature_value)” recorded by the server.

Each client is notified to perform the node splitting operation based on the vertical splitting information “(client_id, record_id, IL, feature_name, feature_value)” recorded by the server. A client corresponding to client_id must know all the information of “(client_id. record_id, IL, feature_name, feature_value)”, and other clients only need to know the IL information.

The server determine the left subtree node obtained by performing the current node splitting as the current processing node.

Each client receives the IL or the information “(client_id, record_id, IL, feature_name, feature_value)” from the server and performs the vertical node splitting operation. If there is the information “(client_id, record_id, IL, feature_name, feature_value)”, the client also needs to record and store this information during the splitting. In embodiments of the disclosure, after the splitting is completed, the left subtree node is used as the current processing node.

The server returns to the block S3002 to continue the subsequent processing, and each client returns to the block S3002 to wait for a message from the server. It is understandable that since only the node splitting of the current node is completed, the node splitting also need to be performed on the left subtree node and the right subtree node of a next level. Therefore, the server returns to the block S3002 to perform the node splitting on a next node.

The server performs the node splitting using the horizontal mode, i.e., splits the current node based on the information “(k, value)” obtained by the horizontal mode, to obtain the IL information and broadcast the IL information to each client. The IL can be represented by a following equation:

S_{IL}={ID|ID^{k}<value},

where ID^{k} represents the value of the instance ID for the feature k, and S_{IL} represents the IL.

Each client receives the IL broadcasted by the server, determines the IL and IR of the current node according to the IL in combination with the data having non-common IDs in the native data, and performs the node splitting operation. It is understandable that the determination of the IL and IR is that if a non-common ID of the native data is not in the IL sent by the server, the non-common ID is in the IR.

The server performs the horizontal node splitting based on the selected feature k and the threshold “value”, and the server broadcasts the information “(k, value)” to each client.

Each client receives the information “(k, value)” from the server and performs the node splitting on data having the common IDs, based on the feature k of the data having the common IDs. If the value of data for the feature k is less than the threshold, e.g., “value”, the ID of this data should be in the IL; otherwise, the ID of this data should be in the IR. If the data does not have the feature k, the ID of this data is in the right subtree space.

The server returns to the block S3002 to continue to perform the splitting operation on the next node, and each client returns to the block S3002 and waits for the message from the server.

The server determines the current node as a leaf node, calculates the weight value wⱼ for this leaf node, and sends the message [Ij(m), wⱼ] to all clients, where Ij(m) is a set of instance IDs in the current node space, and wⱼ is the weight value of the current node.

Each client calculates a new y′(t−1)(i) based on [Ij(m), wⱼ] and backtracks to another non-leaf node of the current tree as the current node, where y′(t−1)(i) represents the label residual corresponding to the i^{th} instance, t represents the current tree, i.e., the t^{th} tree, and (t−1) represents a previous tree.

The server backtracks to another non-leaf node of the current tree as the current node.

If the backtracked node exists and is not empty, the server returns to the block S3002 for the next processing, and each client returns to the block S3002 and waits for the message from the server.

If the backtracked node is empty, the model verification operation is performed.

At block S3005, the server and the verification client verify the target federation learning model.

For example, the server notifies the verification client to perform the verification initializing operation.

The verification client performs the verification initializing operation.

The server selects an ID for starting the verification, initializes the XGB tree, and notifies the verification client to perform the verification.

The verification client initializes the verification information.

The server sends the split node information and the data ID used for the verification to the verification client according to the current XGB tree.

The verification client obtains the corresponding data according to the data ID, and determines a node proceeding direction whether the data should be assigned to the left subtree or the right subtree according to the split node information sent by the server, and returns a determination result to the server.

The server proceed to the next node according to the node proceeding direction returned by the verification client, and determines whether the next node is a leaf node. If the next node is a leaf node, the server records the weight value of the leaf node, calculates the prediction value and stores the prediction value. If the next node is not a leaf node, the server selects a new ID to restart the verification, initializes the XGB tree, and notifies the verification client to restart to perform the verification.

The server records the weight value of the leaf node, calculates the prediction value and stores the prediction value. If the current ID for which the prediction value is calculated is a last one of all predicted IDs, the server sends all prediction results to the client. If the current ID is not a last one of all predicted IDs, the server selects a new ID to start to perform the verification, initializes the XGB tree and notifies the verification client to start to perform the verification.

The server sends all the prediction results to the client.

The verification client receives all the prediction results, determines a final verification result, compares the final verification result with a previous verification result, determines whether the current model should be reserved and used, and notifies the server.

Based on the verification result returned by the verification client, the server determines whether to reserve and use the current model, and notifies all clients.

Each client receives the information broadcasted by the server for processing.

The server determines whether a final round of prediction has been reached. If the final round of prediction has not been reached, the block S3006 is performed.

At block S3006, the server and the clients stop training and the target federated learning model is reserved.

For example, the server stops all trainings, deletes the information, and reserves the model.

Each client stops all trainings, deletes the information, and reserves the model.

In conclusion, with the method for training a federated learning model according to the disclosure, the propensity of automatically selecting a matched learning mode is realized by mixed operation of the horizontal splitting mode and the vertical splitting mode without caring about the data distribution mode, which solves the problems that the training process of the existing federated learning models cannot fully utilize all the data for learning and has poor training results due to insufficient data utilization, reduces the loss of the federated learning model and improves the performance of the federated learning model.

Based on the same concepts, embodiments of the disclosure further provide an apparatus for training a federated learning model corresponding to the method for training a federated learning model.

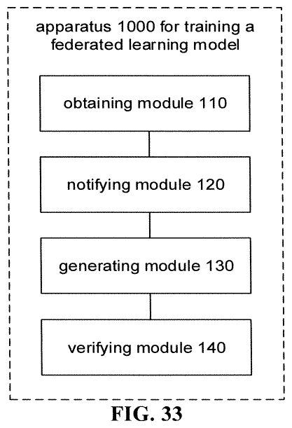

FIG. 33 is a schematic diagram of an apparatus for training a federated learning model according to an embodiment of the disclosure.

As illustrated in FIG. 33, the apparatus for training a federated learning model 1000, applied to a server, is provided. The apparatus includes: an obtaining module 110, a notifying module 120, a first training module 130, a second training module 140, and a generating module 150.

The obtaining module 110 is configured to, obtain a target split mode corresponding to a training node in response to the training node satisfying a preset splitting condition, in which the training node is a node of one boosting tree among a plurality of boosting trees.

The notifying module 120 is configured to notify a client to perform, based on the target split mode, node splitting.

The first training module 130 is configured to perform a next round of training by taking a left subtree node generated by performing the node splitting on the training node as a new training node until an updated training node no longer satisfies the preset splitting condition.

The second training module 140 is configured to perform a next round of training by taking another non-leaf node of the boosting tree as a new training node.

The generating module 150 is configured to, stop training and generate a target federated learning model in response to node datasets of the plurality of boosting trees being empty.

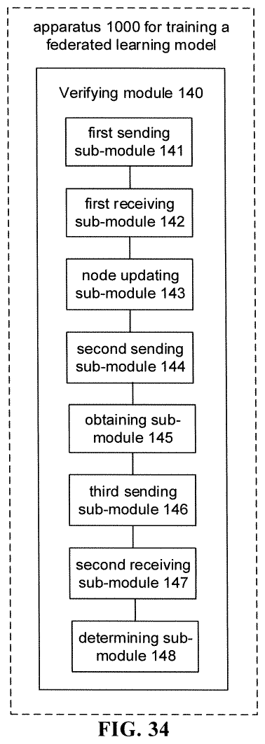

According to embodiments of the disclosure, as illustrated in FIG. 34, the obtaining module 110 in FIG. 33 includes: a first learning sub-module 111, a second learning sub-module 112, and a determining sub-module 113.

The first learning sub-module 111 is configured to obtain a first split value corresponding to the training node by performing, based on a first training set, horizontal federated learning in collaboration with the client.

The second learning sub-module 112 is configured to obtain a second split value corresponding to the training node by performing, based on a second training set, vertical federated learning in collaboration with the client.

The determining sub-module 113 is configured to determine the target split mode corresponding to the training node based on the first split value and the second split value.

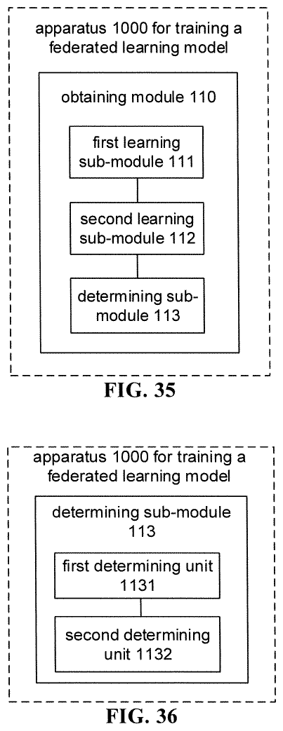

According to embodiments of the disclosure, as illustrated in FIG. 35, the determining sub-module 113 in FIG. 34 includes: a first determining unit 1131 and a second determining unit 1132.

The first determining unit 1131 is configured to determine a larger one between the first split value and the second split value as a target split value corresponding to the training node.

The second determining unit 1132 is configured to determine, based on the target split value, a split mode corresponding to the training node.

According to embodiments of the disclosure, as illustrated in FIG. 36, the first learning sub-module 111 in FIG. 33 includes: a generating unit 1111, a first receiving unit 1112, a third determining unit 1113, and a fourth determining unit 1114.

The generating unit 1111 is configured to generate a first subset of features usable by the training node from the first training set, and send the first subset of features to the client.

The first receiving unit 1112 is configured to, for each feature included in the first subset of features, receive feature values of the feature from the client.

The third determining unit 1113 is configured to, for each feature included in the first subset of features, determine a respective horizontal split value corresponding to the feature for using the feature as a split feature point based on the feature values of the feature.

The fourth determining unit 1114 is configured to determine the first split value of the training node based on the respective horizontal split value corresponding to each feature.

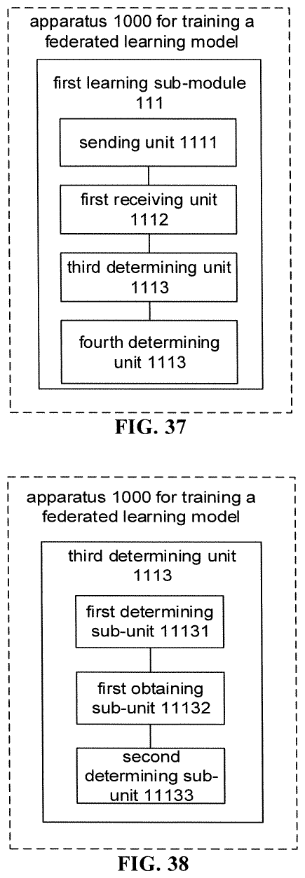

According to embodiments of the disclosure, as illustrated in FIG. 37, the third determining unit 1113 in FIG. 36 includes: a first determining sub-unit 11131, a first obtaining sub-unit 11132, and a second determining sub-unit 11133.

The first determining sub-unit 11131 is configured to determine, for each feature included in the first subset of features, a respective split threshold of the feature based on feature values of the feature.

The first obtaining sub-unit 11132 is configured to obtain, for each feature, a first set of data instance IDs and a second set of data instance IDs corresponding to the feature based on the respective split threshold, in which the first set of data instance IDs includes data instance IDs belonging to a first left subtree space, and the second set of data instance IDs includes data instance IDs belonging to a first right subtree space.

The second determining sub-unit 11133 is configured to determine a respective horizontal split value corresponding to each feature based on the first set of data instance IDs and the second set of data instance IDs.

According to embodiments of the disclosure, the first obtaining sub-unit 11132 is further configured to, for each feature, send the respective split threshold to the client; receive an initial set of data instance IDs corresponding to the training node sent by the client, in which the initial set of data instance IDs is generated by performing the node splitting on the feature via the client based on the respective split threshold, and the initial set of data instance IDs includes the data instance IDs belonging to the first left subtree space; and obtain the first set of data instance IDs and the second set of data instance IDs based on the initial set of data instance IDs and all data instance IDs.

According to embodiments of the disclosure, the first obtaining sub-unit 11132 is further configured to, for each feature, obtain abnormal data instance IDs by comparing each data instance ID included in the initial set of data instance IDs with data instance IDs of the client; obtain the first set of data instance IDs by preprocessing the abnormal data instance IDs; and obtain the second set of data instance IDs based on all the data instance IDs and the first set of data instance IDs.

According to embodiments of the disclosure, as illustrated in FIG. 38, the second learning sub-module 112 in FIG. 34 includes: a notifying unit 1121, a receiving unit 1122, a fifth determining unit 1123, and a sixth determining unit 1124.

The notifying unit 1121 is configured to notify the client to perform, based on the second training set, vertical federated learning.

The receiving unit 1122 is configured to, for each feature, receive respective first gradient information of at least one third set of data instance IDs of the feature sent by the client, in which the third set of data instance IDs includes data instance IDs belonging to a second left subtree space, the second left subtree space is a left subtree space generated by performing the node splitting based on one feature value of the feature, and different feature values correspond to different second left subtree spaces.

The fifth determining unit 1123 is configured to, for each feature, determine a respective vertical split value of the feature based on the respective first gradient information of the feature and total gradient information of the training node.

The sixth determining unit 1124 is configured to determine the second split value corresponding to the training node based on the respective vertical split value corresponding to each feature.

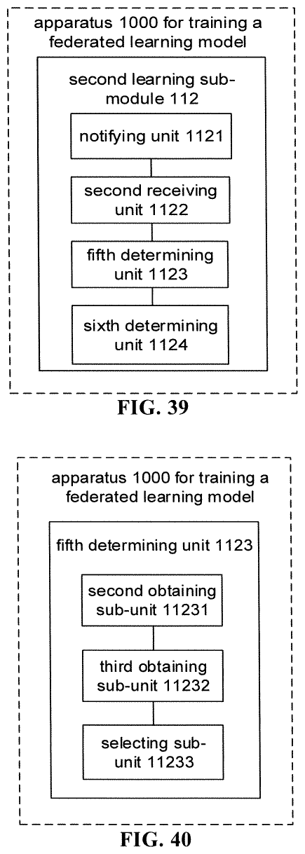

According to embodiments of the disclosure, as illustrated in FIG. 39, the fifth determining unit 1123 in FIG. 38 includes: a second obtaining sub-unit 11231, a third obtaining sub-unit 11232, and a selecting sub-unit 11233.

The second obtaining sub-unit 11231 is configured to obtain respective second gradient information corresponding to the respective first gradient information, based on the total gradient information and the respective first gradient information.

The third obtaining sub-unit 11232 is configured to obtain, for each feature, candidate vertical split values corresponding to the feature based on the respective first gradient information and the respective second gradient information corresponding to the respective first gradient information.

The selecting sub-unit 11233 is configured to, for each feature, select a maximum one among the candidate vertical split values as the vertical split value of the feature.

According to some embodiments of the disclosure, for each feature, the first gradient information includes a sum of first-order gradients of the feature corresponding to data instances belonging to the second left subtree space, and a sum of second-order gradients of the feature corresponding to the data instances belonging to the second left subtree space; and the second gradient information includes a sum of first-order gradients of features corresponding to data instances belonging to second right subtree space, and a sum of second-order gradients of the features corresponding to the data instances belonging to the second right subtree space.

According to embodiments of the disclosure, as illustrated in FIG. 40, the apparatus for training a federated learning model 1000 further includes: a determining module 160 and a sending module 170.

The determining module 160 is configured to determine the training node as a leaf node, in response to the training node not satisfying the preset splitting condition, and obtain a weight value for the leaf node.

The sending module 170 is configured to send the weight value of the leaf node to the client.

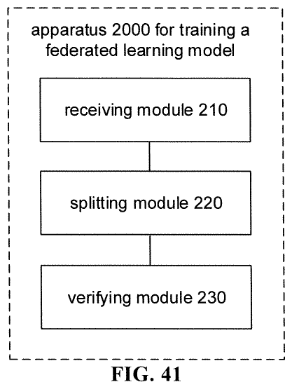

According to embodiments of the disclosure, as illustrated in FIG. 41, the determining module 160 in FIG. 40 includes: a first obtaining unit 161 and a second obtaining unit 162.

The first obtaining unit 161 is configured to obtain data instances belonging to the leaf node.

The second obtaining unit 162 is configured to obtain first-order gradient information and second-order gradient information of the data instances belonging to the leaf node, and obtain the weight value of the leaf node based on the first-order gradient information and the second-order gradient information.

According to embodiments of the disclosure, as illustrated in FIG. 35, the determining sub-module 113 further includes: a sending unit 1133.

The sending unit 1133 is configured to send split information to the client, in which the split information includes the target split mode, a target split feature selected as a feature split point, and the target split value.

According to embodiments of the disclosure, the sending unit 1133 is further configured to: send the split information to clients having labels; receive a set of left subtree spaces sent by the clients having labels; split the second training set based on the set of left subtree spaces; and associate the training node with IDs of the clients having labels.

According to embodiments of the disclosure, the obtaining module 110 is further configured to: receive data instance IDs sent by the client; and determine common data instance IDs that are common between clients based on the data instance IDs, in which the common data instance IDs are configured to instruct the client to determine the first training set and the second training set.

Therefore, with the apparatus of training a federated learning model in the disclosure, the propensity of automatically selecting a matched learning mode is realized by mixing the horizontal splitting mode and the vertical splitting mode without caring about the data distribution mode, which solves the problems that the training process of the existing federated learning models cannot fully utilize all the data for learning and has poor training results due to insufficient data utilization, reduces the loss of the federated learning model and improves the performance of the federated learning model.

Based on the same concepts, embodiments of the disclosure further provide another apparatus for training a federated learning model corresponding to the method for training a federated learning model.

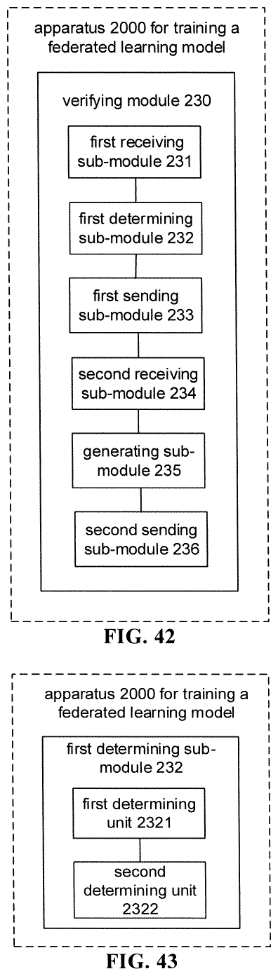

FIG. 42 is a schematic diagram of an apparatus for training a federated learning model according to an embodiment of the disclosure. As illustrated in FIG. 42, the apparatus for training a federated learning model 2000, applied to a client, is provided. The apparatus includes: a first receiving module 210 and a splitting module 220.

The first receiving module 210 is configured to receive a target split mode sent by a server when the server determines that a training node satisfies a preset splitting condition, in which the training node is a node of one boosting tree among a plurality of boosting trees.

The splitting module 220 is configured to perform node splitting on the training node based on the target split mode.

According to embodiments of the disclosure, as illustrated in FIG. 43, the splitting module 220 in FIG. 42 includes: a first learning sub-module 221, a second learning sub-module 222, and a sending sub-module 223.

The first learning sub-module 221 is configured to obtain a first split value corresponding to the training node by performing, based on a first training set, horizontal federated learning.

The second learning sub-module 222 is configured to obtain a second split value corresponding to the training node by performing, based on a second training set, vertical federated learning.

The sending sub-module 223 is configured to send the first split value and the second split value to the server.

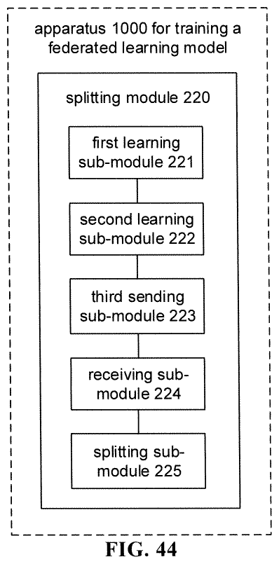

According to embodiments of the disclosure, as illustrated in FIG. 44, the first learning sub-module 221 in FIG. 43 includes: a first receiving unit 2211, a first sending unit 2212, a second receiving unit 2213, and a first obtaining unit 2214.

The first receiving unit 2211 is configured to receive a first subset of features usable by the training node generated by the server from the first training set.

The first sending unit 2212 is configured to, for each feature included in the first subset of features, send a respective feature value of the feature to the server.

The second receiving unit 2213 is configured to, for each feature, receive the respective split threshold of the feature sent by the server.

The first obtaining unit 2214 is configured to, for each feature, obtain, based on the respective split threshold of the feature, an initial set of data instance IDs corresponding to the training node, and send the initial set of data instance IDs to the server.

The initial set of data instance IDs is configured to instruct the server to generate a first set of data instance IDs and a second set of data instance IDs, the first set of data instance IDs and the initial set of data instance IDs both include data instance IDs belonging to a first left subtree space, and the second set of data instance IDs includes data instance IDs belonging to a first right subtree space.

According to embodiments of the disclosure, the first obtaining unit 2214 is further configured to, for each feature, compare the respective split threshold of the feature with values of data instances for the feature, obtain data instance IDs of data instances whose values for the feature are less than the respective split threshold to form the initial set of data instance IDs.

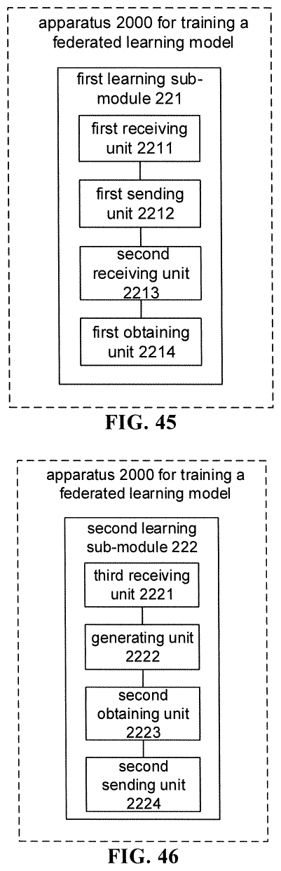

According to embodiments of the disclosure, as illustrated in FIG. 45, the second learning sub-module 222 in FIG. 43 includes: a third receiving unit 2221, a generating unit 2222, a second obtaining unit 2223, and a second sending unit 2224.

The third receiving unit 2221 is configured to receive a gradient information request from the server.

The generating unit 2222 is configured to generate a second subset of features from the second training set based on the gradient information request.

The second obtaining unit 2223 is configured to, for each feature included in the second subset of features, obtain respective first gradient information of at least one third set of data instance IDs of the feature, in which the third set of data instance IDs includes data instance IDs belonging to a second left subtree space, the second left subtree space is a left subtree space generated by performing the node splitting according to one feature value of the feature, and different feature values correspond to different second left subtree spaces.

The second sending unit 2224 is configured to, for each feature, send the respective first gradient information of the at least one third set of data instance IDs to the server.

According to embodiments of the disclosure, as illustrated in FIG. 46, the second obtaining unit 2223 in FIG. 45 includes: a bucket dividing sub-unit 22231 and a second obtaining sub-unit 22232.

The bucket dividing sub-unit 22231 is configured to, for each feature, obtain all feature values of the feature, and divide the feature into buckets based on the feature values.

The second obtaining sub-unit 22232 is configured to, for each feature, obtain the respective first gradient information of the at least one third set of data instance IDs of buckets of the feature.

According to embodiments of the disclosure, as illustrated in FIG. 43, the splitting module 220 in FIG. 42 includes: a receiving sub-module 224 and a splitting sub-module 225.

The receiving sub-module 224 is configured to receive split information from the server, in which the split information includes the target split mode, a target split feature selected as a feature split point, and a target split value.

The splitting sub-module 225 is configured to perform the node splitting on the training node based on the split information.

According to embodiments of the disclosure, the splitting sub-module 225 is further configured to: send a left subtree space generated by performing the node splitting to the server.

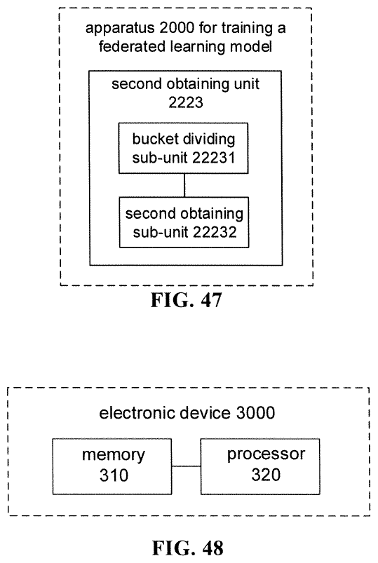

According to embodiments of the disclosure, as illustrated in FIG. 47, the apparatus 1000 further includes: a second receiving module 230, a determining module 240, and an inputting module 250.

The second receiving module 230 is configured to receive a weight value of a leaf node sent by the server, in response to the training node being a leaf node.

The determining module 240 is configured to determine a residual of data contained in the leaf node based on the weight value of the leaf node.

The inputting module 250 is configured to determine the residual as a residual input for a next boosting tree.

With the apparatus for training a federated learning model according to the disclosure, the client can receive the target split mode from the server when the server determines that the training node satisfies the preset splitting condition. The training node is a node of one boosting tree among the plurality of boosting trees. The node splitting is performed on the training node based on the target split mode. The propensity of automatically selecting a matched learning mode is realized by mixing the horizontal splitting mode and the vertical splitting mode, without considering the data distribution mode, which solves the problems that the training process of the existing federated learning models cannot fully utilize all the data for learning and has poor training results due to insufficient data utilization, reduces the loss of the federated learning model and improves the performance of the federated learning model.

Based on the same concepts, embodiments of the disclosure also provides an electronic device.

FIG. 48 is a schematic diagram of an electronic device according to an embodiment of the disclosure. As illustrated in FIG. 48, the electronic device 3000 includes: a memory 310, a processor 320 and computer programs stored on the memory 310 and runnable on the processor 320. When the computer programs are executed by the processor, the above method for training a federated learning is implemented.

Those skilled in the art should understand that the embodiments of the disclosure provide a method, a system, or a computer program product. Therefore, the disclosure may take the form of an entirely hardware embodiment, an entirely software embodiment, or an embodiment combining software and hardware aspects. Moreover, the disclosure may take the form of a computer program product implemented on one or more computer usable storage medium (including, but not limited to, disk memory, Compact Disc Read-Only Memory (CD-ROM), and optical memory) containing computer usable program codes therein.

The disclosure is described by reference to flowcharts and/or block diagrams of methods, devices (systems), and computer program products according to the embodiments of the disclosure. It is understood that each process and/or box in the flowchart and/or block diagram, and the combination of processes and/or boxes in the flowchart and/or block diagram, may be implemented by computer program instructions. These computer program instructions may be provided to a processor of a general purpose computer, a dedicated computer, an embedded processor, or other programmable data processing device to produce a machine, such that the instructions executed by the processor of the computer or other programmable data processing devices produce a device for implementing the functions specified in one process or multiple processes in the flowchart and/or one box or multiple boxes in the block diagram.

These computer program instructions may also be stored in a computer readable memory capable of directing a computer or other programmable data processing devices to operate in a particular mode, such that the instructions stored in such computer readable memory produce an article of manufacture including an instruction device that implements the function specified in one or more processes of a flowchart and/or one or more boxes of a block diagram.

These computer program instructions may also be loaded onto a computer or other programmable data processing devices, to perform a series of operational steps on the computer or other programmable devices to produce computer-implemented processing, such that the instructions executed on the computer or other programmable devices provide steps for implementing the functions specified in one or more processes of the flowchart and/or one or more boxes of the block diagram.

It is understandable that any reference symbols located between the brackets in a claim should not be constructed as a limitation of the claim. The word “including” does not exclude the existence of parts or steps not listed in the claim. The word “one” or “a” preceding a part does not exclude the existence of multiple such parts. The disclosure can be implemented with the aid of hardware including several different components and an appropriately programmed computer. In a unit claim listing several devices, several of these devices may be embodied by the same hardware item. The use of the words “first”, “second”, and “third” does not indicate any order. These words may be interpreted as names.

Although preferred embodiments of the disclosure have been described, those skilled in the art may make additional changes and modifications to these embodiments once the basic inventive concepts are known. Therefore, the appended claims are intended to be construed to include the preferred embodiments and all changes and modifications that fall within the scope of the disclosure.

Obviously, those skilled in the art may make various modifications and variations of the disclosure without departing from the spirit and scope of the disclosure. Therefore, if these modifications and variations of the disclosure fall within the scope of the claims of the disclosure and its technical equivalents, the disclosure is also intended to include such modifications and variations.

1. A method for training a federated learning model, performed by a server, the method comprising:
obtaining a target split mode corresponding to a training node in response to determining that the training node satisfies a preset splitting condition, in which the training node is a node of one boosting tree among a plurality of boosting trees;
notifying a client to perform, based on the target split mode, node splitting;
performing a next round of training by taking a left subtree node generated by performing the node splitting as a new training node until an updated training node does not satisfy the preset splitting condition;
performing a next round of training by taking another non-leaf node of the boosting tree as a new training node; and
stopping training and generating a target federated learning model in response to determining that a node dataset of the plurality of boosting trees is empty.

2. The method of claim 1, wherein obtaining the target split mode corresponding to the training node comprises:
obtaining a first split value corresponding to the training node by performing, based on a first training set, horizontal federated learning in collaboration with the client;
obtaining a second split value corresponding to the training node by performing, based on a second training set, vertical federated learning in collaboration with the client; and
determining the target split mode corresponding to the training node based on the first split value and the second split value

3. The method of claim 2, wherein determining the target split mode corresponding to the training node based on the first split value and the second split value comprises:
determining a larger one between the first split value and the second split value as a target split value corresponding to the training node; and
determining, based on the target split value, the target split mode corresponding to the training node.

4. The method of claim 2, wherein obtaining the first split value corresponding to the training node by performing, based on the first training set, the horizontal federated learning in collaboration with the client comprises:
generating a first subset of features usable by the training node from the first training set, and sending the first subset of features to the client;
for each feature contained in the first subset of features, receiving feature values of the feature from the client;
for each feature contained in the first subset of features, determining a respective horizontal split value corresponding to the feature for using the feature as a split feature point based on the feature values of the feature; and
determining the first split value of the training node based on the respective horizontal split value corresponding to each feature.

5. The method of claim 4, wherein for each feature contained in the first subset of features, determining the respective horizontal split value corresponding to the feature for using the feature as a split feature point based on the feature values of the feature comprises:
for each feature contained in the first subset of feature, determining a respective split threshold of the feature based on the feature values of the feature;
for each feature contained in the first subset of feature, obtaining a first set of data instance identity documents and a second set of data instance identity documents corresponding to the feature based on the respective split threshold, wherein the first set of data instance identity documents comprises data instance identity documents belonging to a first left subtree space, and the second set of data instance identity documents comprises data instance IDs belonging to a first right subtree space; and
for each feature contained in the first subset of feature, determining the respective horizontal split value corresponding to the feature based on the first set of data instance identity documents and the second set of data instance identity documents.

6. The method of claim 5, wherein obtaining the first set of data instance identity documents and the second set of data instance identity documents corresponding to the feature based on the respective split threshold comprises:
for each feature, sending the respective split threshold to the client;
for each feature, receiving an initial set of data instance identity documents corresponding to the training node sent by the client, wherein the initial set of data instance identity documents is generated by performing the node splitting for the feature via the client based on the respective split threshold, and the initial set of data instance identity documents comprises the data instance identity documents belonging to the first left subtree space; and
for each feature, obtaining the first set of data instance identity documents and the second set of data instance identity documents based on the initial set of data instance identity documents and all data instance identity documents.

7. (canceled)

8. The method of claim 2, wherein obtaining the second split value corresponding to the training node by performing, based on the second training set, the vertical federated learning in collaboration with the client comprises:
notifying the client to perform, based on the second training set, the vertical federated learning;
for each feature, receiving respective first gradient information of at least one third set of data instance identity documents of the feature sent by the client, wherein the third set of data instance identity documents comprises data instance identity documents belonging to a second left subtree space, the second left subtree space is a left subtree space generated by performing the node splitting based on one feature value of the feature, and different feature values correspond to different second left subtree spaces;
for each feature, determining a respective vertical split value of the feature based on the respective first gradient information and total gradient information of the training node; and
determining the second split value corresponding to the training node based on the respective vertical split value corresponding to each feature.

9. The method of claim 8, wherein for each feature, determining the respective vertical split value of the feature based on the respective first gradient information and the total gradient information of the training node comprises:
for each feature, obtaining respective second gradient information corresponding to the respective first gradient information based on the total gradient information and the respective first gradient information;
for each feature, obtaining candidate vertical split values corresponding to the feature based on the respective first gradient information and the respective second gradient information corresponding to the respective first gradient information; and
for each feature, selecting a maximum one among the candidate vertical split values as the respective vertical split value of the feature.

10. (canceled)

11. The method of claim 1, further comprising:
determining the training node as a leaf node in response to the training node not satisfying the preset splitting condition, and obtaining a weight value of the leaf node; and
sending the weight value of the leaf node to the client.

12. The method of claim 11, wherein obtaining the weight value of the leaf node comprises:
obtaining data instances belonging to the leaf node; and
obtaining first-order gradient information and second-order gradient information of the data instances belonging to the leaf node, and obtaining the weight value of the leaf node based on the first-order gradient information and the second-order gradient information.

13. The method of claim 3, before notifying the client to perform, based on the target split mode, the node splitting, further comprising:
sending split information to the client, wherein the split information comprises the target split mode, a target split feature selected as a feature split point, and the target split value.

14. The method of claim 13, wherein in response to the target split mode being the vertical split mode, before notifying the client to perform, based on the target split mode, the node splitting, the method further comprises:
sending the split information to clients having labels;
receiving a set of left subtree spaces sent by the clients having labels;
splitting the second training set based on the set of left subtree spaces; and
associating the training node with identity documents of the clients having labels.

15. (canceled)

16. The method of claim 1, wherein after notifying the client to perform, based on the target split mode, the node splitting, the method further comprises:
obtaining an updated training node;
stopping the training and generating the target federated learning model in response to determining that an updated training node satisfies a training stop condition; and
obtaining a verification set and verifying the target federated learning model in collaboration with a verification client based on the verification set, wherein the verification client is one of clients involved in the training of the federated learning model.

17-27. (canceled)

28. A method for training a federated learning model, performed by a client, the method comprising:
receiving a target split mode sent by a server in response to determining by the server that a training node satisfies a preset splitting condition, wherein the training node is a node of one boosting tree among a plurality of boosting trees; and
performing node splitting on the training node based on the target split mode.

29-36. (canceled)

37. The method of claim 28, wherein after performing the node splitting on the training node based on the target split mode, the method further comprises:
receiving a verification set sent by the server, and verifying a target federated learning model based on the verification set.

38. The method of claim 37, wherein verifying the target model in collaboration with a verification client based on the verification set comprises:
receiving a data instance identity document contained in the verification set and split information of a verification node from the server, wherein the verification node is a node of one boosting tree among a plurality of boosting trees;
determining a node proceeding direction of the verification node, based on the data instance identity document and the split information; and
sending the node proceeding direction to the server, to allow the server to proceed to a next node along the node proceeding direction and take the next node as an updated verification node.

39. The method of claim 38, wherein determining the node proceeding direction of the verification node based on the data instance identity document and the split information comprises:
for each feature corresponding to the data instance identity document, based on the data instance identity document, determining a respective feature value of the feature; and
determining the node proceeding direction based on the split information and the respective feature value of each feature.

40. The method of claim 38, further comprising:
receiving a model prediction value of a data instance represented by the data instance identity document sent by the server in response to determining that all data instance identity documents contained in the verification set are verified;
obtaining a final verification result based on the model prediction value, and generating a verification indication message for indicating whether to reserve and use the target federated learning model by comparing the verification result with a previous verification result; and
sending the verification indication message to the server.

41-90. (canceled)

91. An electronic device comprising: a memory, a processor and computer programs stored on the memory and runnable on the processor, wherein when the computer programs are executed by the processor, the processor is configured to:
obtain a target split mode corresponding to a training node in response to determining that the training node satisfies a preset splitting condition, in which the training node is a node of one boosting tree among a plurality of boosting trees;
notify a client to perform, based on the target split mode, node splitting;
perform a next round of training by taking a left subtree node generated by performing the node splitting as a new training node until an updated training node does not satisfy the preset splitting condition;
perform a next round of training by taking another non-leaf node of the boosting tree as a new training node; and
stop training and generate a target federated learning model in response to determining that a node dataset of the plurality of boosting trees is empty.

92. (canceled)

93. An electronic device comprising: a memory, a processor and computer programs stored on the memory and runnable on the processor, wherein when the computer programs are executed by the processor, a method for training a federated learning model of claim 28 is performed.
